(19) United States
(12) Patent Application Publication
(10) Pub. No.: US 2020/0032763 A1
(43) Pub. Date: Jan. 30, 2020

(54) POWER GENERATOR

(71) Applicant: James Theodore Berling, Milford, OH (US)

(72) Inventor: James Theodore Berling, Milford, OH (US)

(21) Appl. No.: 16/526,367

(22) Filed: Jul. 30, 2019

Related U.S. Application Data
(60) Provisional application No. 62/764,356, filed on Jul. 30, 2018.

(51) Int. Cl. F03B 13/10; G05F 1/67; H02K 7/18; H02N 99/00

(52) U.S. Cl. CPC F03B 13/10; G05F 1/67; F03B 13/12; H02N 99/00; H02K 7/1892

(57) ABSTRACT

A mechanical device that can generate decentralized electrical power and/or hydraulic fluid pressure on a continual basis, using fully integrated omnipresent energy sources which remain unchanged.

### CROSS-REFERENCE TO RELATED APPLICATION

This application claims the benefit of priority of U.S. provisional application No. 62/764,356, filed 30 Jul. 2018, the contents of which are herein incorporated by reference.

### BACKGROUND OF THE INVENTION

The present invention relates to power generators and, more particularly, to a mechanical device that can generate decentralized electrical power and/or hydraulic fluid pressure on a continual basis, using fully integrated omnipresent energy sources which remain unchanged.

Currently, in the United States, a vast majority of electrical power is transmitted across the power grid, and is relatively available for almost all Americans. In less fortunate countries, however, there is a significant density of individuals who never could afford such a benefit as electricity.

There are though, drawbacks in America to delivering power across the grid. First, heavy reliance on one-type of infrastructure presents a vulnerability to those who would want to do America harm. Second, the power grid is notoriously part of the problem of global warming. In fact, all non-renewable power generating sources generate pollution which is distributed into our air, water, and will continuously contribute to global warming.

Ninety percent of all power generation sources use energy sources such as gasoline, natural gas, coal and other forms of energy that requires combustion for their energy source. Therefore, these energy sources must be continuously replenished in order to continue to generate power. These systems utilize antiquated technology and techniques, which are costly to operate and are still dependent on other technologies, such as mining and transportation for their raw materials. Furthermore, current power generation systems mandate the removal of by-products from the combustion of these energy sources.

As can be seen, there is a need for a mechanical device that can generate decentralized electrical power and/or hydraulic fluid pressure on a continual basis, using fully integrated omnipresent energy sources which remain unchanged. Such mechanical device may include a compound mechanical lever providing two classic mechanical levers that share a common fulcrum, while the omnipresent energy sources include buoyance and gravitational energy sources. The buoyance and gravitational energy sources are spaced apart and uniquely arranged along the compound mechanical lever so as to provide rotational equilibrium between the omnipresent energy sources, and thus a power generator that generates decentralized electrical power or hydraulic power, as described and disclosed herein.

The utilization of decentralized electrical and hydraulic power fueled by omnipresent energy sources yield efficiencies near unity and a cost which can be one-tenth the present rate of current power generating plants. Furthermore, the present invention does not contribute to global warming.

The power generator embodied in the present invention operates fully submerged and therefore its operations are not directly or indirectly affected by localized weather and atmospheric conditions as almost all other power generating sources are. The power generator of the present invention is scalable and does not require a backup system such as a battery or other types of energy storage systems. The present invention can also be mounted in a container and operatively associated with, for example, a city bus for continuously providing power.

Alternatively, the present invention can be scaled up to the size of a power plant to meet the needs of tens of thousands of individuals. Scaling involves coupling systemic power generators to provide a fixed level of power output, wherein back-up source of power or battery support will not be required.

Because the power generator of the present invention (colloquially known as the Berling's Gravity Buoyancy-Engine, or “BGB-Engine”, or hereafter as BGB-E) does not change its energy sources as it can utilize these sources of energy on a continuous basis. More importantly, the energy sources utilized in the BGB-E are in all places at all times and are totally “free”. As a result, the present invention simultaneously can minimize the vulnerability that is the electrical grid, reduce the problem of global warming, and bring energy to those individuals in parts of the world who cannot currently afford to buy electricity.

### SUMMARY OF THE INVENTION

In one aspect of the present invention, a power generator includes the following: a compound lever comprising two class II mechanical levers sharing a common fulcrum; and at least one active energy unit providing one gravitational vessel positioned in an initial position along the compound lever; and two buoyancy vessels for said gravitational vessel and spaced apart therefrom, wherein the two buoyancy vessels contain the same net weight as said gravitational vessel net weight so that the two buoyancy vessels and said gravitational vessel have the same torque with opposite polarities relative to the fulcrum.

In another aspect of the present invention, the power generator includes the following: a compound lever comprising two class II mechanical levers sharing a common fulcrum; at least one active energy unit providing one gravitational vessel positioned in an initial position along the compound lever; two buoyancy vessels for said gravitational vessel and spaced apart therefrom, wherein the two buoyancy vessels contain the same net weight as said gravitational vessel net weight so that the two buoyancy vessels and said gravitational vessel have the same torque with opposite polarities relative to the fulcrum, wherein each class II mechanical lever performs a power stroke simultaneously yet independently of each other when pivoting about the fulcrum, wherein each of the buoyancy and gravitational vessels are positioned along the composite lever so that an initial force of each vessel becomes a respective torques once so positioned, and wherein the respective torques of the gravitational vessels have an opposite polarity than that of the two buoyancy vessels of each active energy unit so that a summation of said respective torques will be equal to zero; a stand-alone position provided at each opposing ends of the composite lever, wherein a differential translational displacement by way of the potential energy displaces each gravitational vessel from the initial position to an adjacent stand-alone position to generate power; a hydraulic actuator operatively associated to each side of the fulcrum, wherein each hydraulic actuator actuators is configured to use mechanical force from radial motion of the compound lever generated during each power stroke; one or more high-pressure hydraulic accumulators coupled to each hydraulic actuator for retrievably storing hydraulic pressure for providing continuous source of a potential energy to the hydraulic actuators; an upper track and a lower track spaced apart along the composite lever; an axle attached each buoyancy and gravitational vessel; a set of wheels mounted to each axle; each set of wheels operatively associated with the upper or lower track, wherein each gravitational vessel is engaged with the lower track; and a chain like connector placed around each axle for enabling rotation and vertical displacement without being restrained.

These and other features, aspects and advantages of the present invention will become better understood with reference to the following drawings, description and claims.

### BRIEF DESCRIPTION OF THE DRAWINGS

FIG. 1A: is a Neutral Position Diagram of an exemplary embodiment of the present invention;

FIG. 1B: is a First DTD Activity Diagram of an exemplary embodiment of the present invention;

FIG. 1C: is a First ½ Simultaneously Generated Power Stroke SGPS Diagram of an exemplary embodiment of the present invention;

FIG. 1D: is a Second Application of the DTD Activity Diagram of an exemplary embodiment of the present invention;

FIG. 1E: is a First Full Generated Power Stroke SGPS Diagram of an exemplary embodiment of the present invention;

FIG. 2: is a schematic view of a Hydraulic Equipment Control Room with Output Electrical Alternators of an exemplary embodiment of the present invention;

FIG. 3: is an Incline-Plane Analysis Diagram of an exemplary embodiment of the present invention;

FIG. 4: is an In-Ground Power Plant Diagram of an exemplary embodiment of the present invention;

FIG. 5: is a schematic view of the Work Required to Apply the Differential Translational Displacement Activity Diagram of an exemplary embodiment of the present invention;

FIG. 6: is a schematic view of the Action of Hydraulic Actuators Used to Perform the DTD Activity Diagram of an exemplary embodiment of the present invention;

FIG. 7: is a schematic view of ½ of a Compound Class-II Mechanical Lever with the Lever's Properties of an exemplary embodiment of the present invention;

FIG. 8A: is a side perspective view of an exemplary embodiment of the present invention;

FIG. 8B: is a front perspective view of an exemplary embodiment of the present invention;

FIG. 8C: is a rear side perspective view of an exemplary embodiment of the present invention;

FIG. 8D: is a rear perspective view of an exemplary embodiment of the present invention;

FIG. 8E: is a side perspective view of an exemplary embodiment of the present invention;

FIG. 8F: is a bottom rear perspective view of an exemplary embodiment of a MWM of the present invention;

FIG. 9: is a schematic view of an extended support system ESS #48 used to insert or retract a fully assembled BGB-Engine from a container of an exemplary embodiment of the present invention;

FIG. 10A is a top down view of a BGB-Engine during the recovery process determination of an exemplary embodiment of the present invention;

FIG. 10B is a top down view of a BGB-Engine with ½ of the recovery process completed of an exemplary embodiment of the present invention;

FIG. 10C is a top down view of a BGB-Engine with ½ of the recovery process completed of an exemplary embodiment of the present invention, illustrating a final segment of the DTD activity;

FIG. 11A is a schematic view of a special design of the CC2ML of the exemplary embodiment, which is utilized in the BGB-Engine's MWM:

FIG. 11B is a side view of the CC2ML of an exemplary embodiment of the present invention, illustrating 1-2 of the CC2ML with a radial displacement equivalent to that expected from a typical power stroke and which also includes various parameters that are utilized in the BGB-Engine design, MWM #45; and

FIG. 12 is a top down view of a BGB-Engine of an exemplary embodiment of the present invention, illustrating the MWM #45 in a test configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

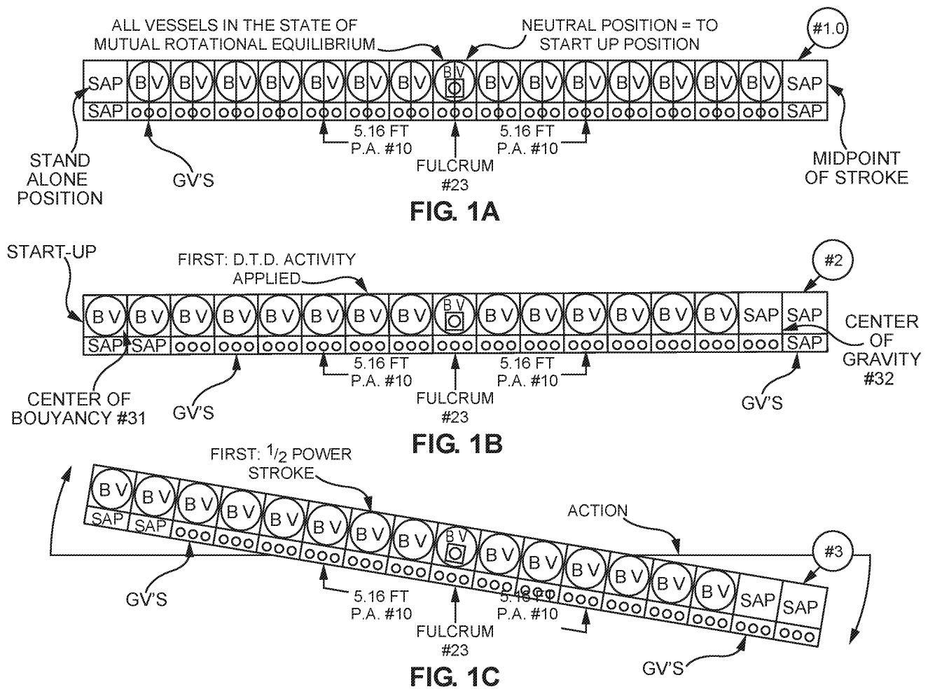

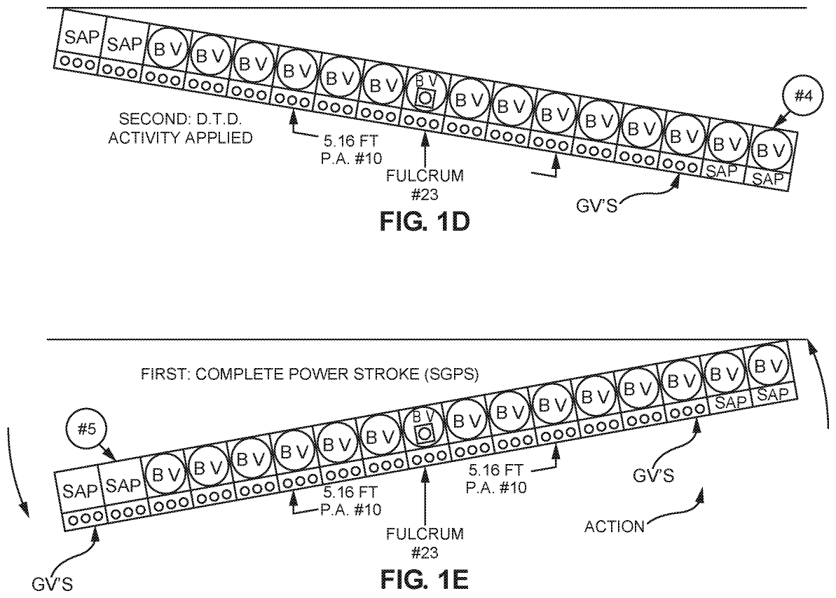

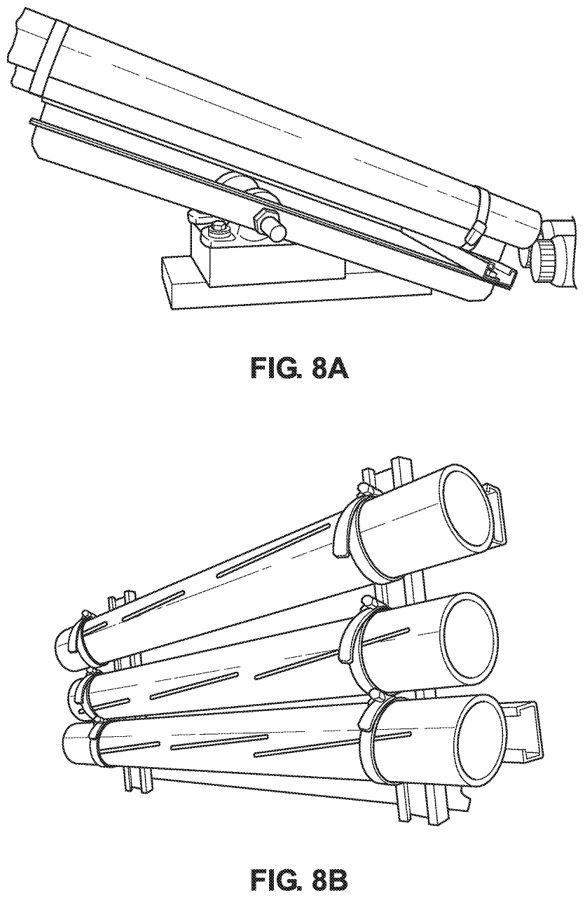

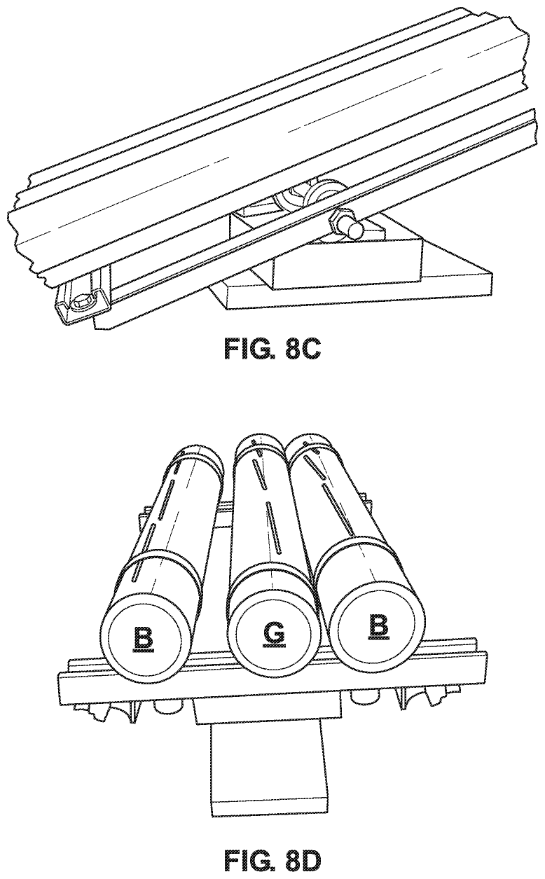

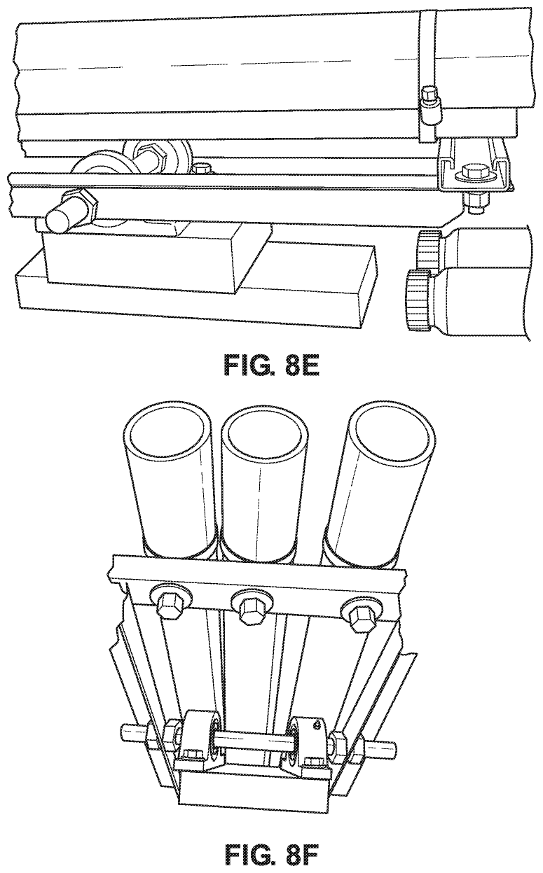

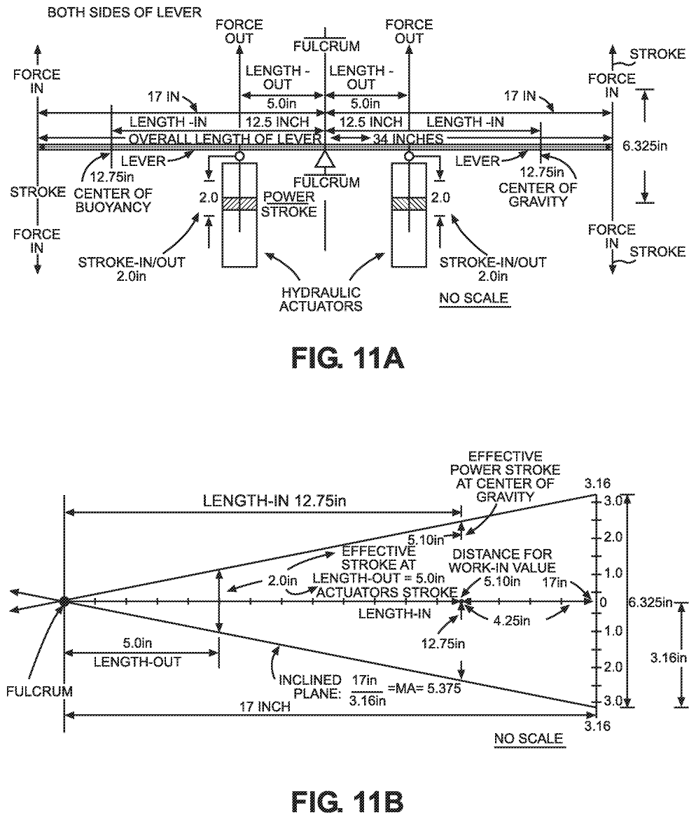

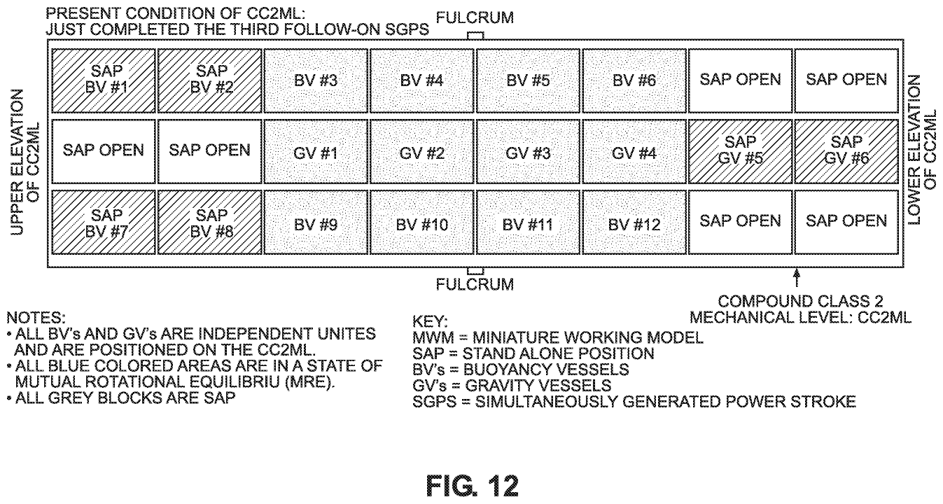

Referring to FIGS. 1A through 12, an individual can construct a compound class-II mechanical lever (CC2ML) that includes two classic mechanical levers that share a common fulcrum.

The power generator, BGB-E, embodied by the present invention may provide at least one gravitational vessel (GV) and two buoyancy vessels (BVs) for each GV. One line of GVs may be positioned in the middle portion of the CC2ML with a line of BVs positioned on each side of the line of GVs. The two BVs should contain the same net weight/force as the GVs net weight. These 2 BVs and the one GV should have the same torque with opposite polarities so that their torques would cancel, maintaining the BVs and GV in the state of rotational equilibrium. The BGB-E operates fully submerged, though it can be mounted in a container.

The BGB-E generates decentralized electrical power on a 24/7 basis or it can provide high pressure hydraulic fluid power to, for instance, provide torque for mechanical operations. Such decentralized power has a high efficiency percent and minimal operational cost.

### Glossary of Terms

Compound class II mechanical lever (CC2ML #1): This device is the main component in the present invention. The CC2ML is comprised of two class II mechanical levers which share a common fulcrum.

Hydraulic equipment control room (HECR #2): The control room contains standard hydraulic components plus an electric alternator for electrical power output.

Gravity Buoyancy Engine (BGB-E #3): The present invention. Webster's Dictionary defines an “Engine” as: “A machine for converting any of various forms of energy into mechanical force or motion”.

In-Ground Power Plant (IGPP #4): This component is utilized when multiple BGB-Es are coupled together. The IGPP operates independently but generates power collectively, allowing power to be continuously provided, while one or more BGB-Es are being repaired. This capability means that the BGB-Es will never require a back-up system in order to maintain a continuous 24/7 operation.

Simultaneously Generated Power Stroke (SGPS #5): Each side of the CC2ML #1 performs its power stroke, as an independent class II mechanical lever; although, both sides of the CC2ML #1 generate their power stroke simultaneously as well as jointly cause the rotation of the CC2ML #1.

Hydraulic actuator (HA #6-#9): The HA may include four single-ended double acting linear hydraulic actuators providing power to physically displace BVs #17 or GVs #18 during the application of the DTD #16 activity. Each of these HA actuators obtain their energy from the stored hydraulic fluid located in the HPHAs #11. This high-pressure hydraulic fluid is placed into the HPHAs #11 during each SGPS #5. Rotary hydraulic motors can also be used as replacements for the linear hydraulic actuators.

Power Actuator (PA #10): This component may be a single ended double acting linear high-pressure hydraulic actuator operatively associated to the CC2ML #1 on each side of its Fulcrum #23. These actuators use the mechanical force from the radial motion of the CC2ML #1, which is generated during the SGPS #5, to displace the piston rods of these actuators, whereby approximately 3000-psi hydraulic pressure is simultaneously generated and immediately placed into HPHA #11. These PA #10 linear actuators may be used as silent, high pressure pumps.

High pressure hydraulic accumulators (HPHA #11): These components are high-pressure hydraulic accumulators for providing another continuous source of potential energy, which is available for any purpose as it is an integral component of the BGB-E. These accumulators may be is used as a primary high-pressure source of storable energy when integrated to the BGB-E.

Another source of potential energy (ASPE #12): Similar to HPHA #11 for storing hydraulic fluid pressure as potential energy.

Omni-Present Energy Sources (OPES #13): The “Omni-Present” Energy Sources of Buoyancy and Gravity which are totally independent and totally free, and in certain embodiments integral to the BGB-E.

Electric Alternator (EA #14): This component may be powered by a high torque hydraulic motor which obtains its energy from the high-pressure hydraulic fluid stored in the HPHA #11. The hydraulic motors output rotates the electric alternator which is used to supply electricity for distribution as desired.

Mutual Rotational Equilibrium (MRE #15): A process whereby the OPES #13 are positioned on the CC2ML #1 in such a manner, that their initial respective forces become torques once so positioned. Additionally, due the positioning of the buoyancy vessels BVs #17 and the Gravity vessels GV #18 on the CC2ML #1, their respective torques will exhibit the opposite polarity while simultaneously their respective positions on the CC2ML will yield exactly the same magnitude of torque for both the BVs and GVs. Since, these torques have the opposite polarity, the summation of their respective torques will be equal to zero. Therefore, while these sources of energy are in the conditions being described, their net effect upon the CC2ML #1 is equal to zero. MRE is utilized to maintain a condition of equilibrium for the other sources of potential energy which are exact replicas of the two active sources of energy.

Differential Translational Displacement (DTD #16): The DTD activity is used to Differentially Displace the energy sources of BVs #17 and GVs #18 from their respective positions on the CC2ML #1, which in turn may be governed by MRE, and to place them into their respective stand-alone positions SAP #21 also located on the CC2ML #1. It is important to note that the requirement identified in the DTD #16 activity for the displacements to be differentially applied, automatically means that each BV or each GV being displaced, will only be required to move one half of the distance in order to achieve a total separation of distance being desired, due to the differential nature of the displacements being imposed. Additionally, the BGB-E is adaptable to accommodate more than one BV or more than one GV to be positioned into the SAP #21 on the CC2ML #1; in such an embodiment, certain rules apply may to the length extension of the CC2ML #1 so that the power output of the BGB-E can easily be increased. In that the BV is always larger than the GV, it is used as our reference measurement. If only one BV or one set of BVs is being utilized, the rule is to add one half of the BVs diameter's dimension to each end of the CC2ML. The rule continues with, if two BVs or two sets of BVs are placed into the SAP #21, a dimension equal to the diameter of the BV, is required to be added to each end of the CC2ML #1. Furthermore, a dimension equal to 1.5 times the diameter of the BV is required, if three BVs or three sets of BVs are placed into the SAP #21.

Buoyancy Vessel (BV #17): All of the BVs placed on the CC2ML are totally independent sources of OPES #13, and they are fully integrated into the BGB-E. The BVs generate power when they are positioned in SAP's #21. These BVs always retain their initial force which they contained at the time that they were originally positioned onto the CC2ML #1. Additionally, these BVs respond to various sets of conditions such as MRE #15 and DTD #16 activity.

Gravitational vessels (GV #18): All of the GVs placed on the CC2ML are totally independent sources of OPES #13, and they are fully integrated into the BGB-E. The GVs generate power when they are positioned in SAP's #21. These GVs always retain their initial force which they contained at the time that they were originally positioned onto the CC2ML #1. Additionally, these GVs respond to various sets of conditions such as MRE #15 and DTD #16 activity.

The Follow-On Simultaneously Generated Power Stroke (FO-SGPS #19): The follow-on SGPS #19 occurs when the GVs and BVs move to their new power generation position and are able to initiate the next power stroke.

Electric Generator (EG #20): This component can also be an alternator. Both are powered by a hydraulic motor which obtains its energy from the high-pressure hydraulic fluid stored in the HPHA #11.

Stand-Alone-Position (SAP #21): The SAP #21 is an integral part of the CC2ML #1 and are normally located at each end of the CC2ML #1. The OPES are generally displaced into these SAP #21 using the DTD activity #16, so that they can utilize their respective energy coupled with their respective new position on the CC2ML #1, to generate power.

Sub-surface Electrical Power Distribution System (SSEPDS #22): The SSEPDS #22 is the distribution system that may be utilized for all applications where the BGB-E in providing decentralized electrical power.

Fulcrum #23: The balance point or pivot point for the CC2ML #1.

Hydraulic Motor (HM #24): Powers the electrical generator or alternator and is located in the HECR #2.

In-House Electrical Power (IHEP #25): Electrical power for the HECR #2, which may be located in the HECR #2.

Hydraulic Filters (HF #26): low pressure return lines filters, which are located in the HECR #2. The replacement of these filters can be accommodated at any time without interrupting the operation of a single or multiple BGB-E due to the arrangement of the flow control valves that operate the multiple filter arrangement.

Oil Reservoir (OR #27): Storage of low-pressure hydraulic fluid.

Nitrogen regulator (N2R #28-A): Control regulator for the N2 nitrogen gas storage bottle: N2bottle-#28-B: for Nitrogen gas storage. N2gas #28-CL: The actual gas which is used to pre-charge a gas bladder which may be required for all hydraulic accumulators. All of these components are located in the HECR #2.

Inclined Plane (IP #29): The Mechanical Advantage MA of the IP #29 is extremely valuable asset in the BGB-E. Its utilization takes place after each SGPS #5 and during the application of the complete DTD #16 activity. The steeper the slope of an IP #29, the lower the MA value and consequently more work is required to operate the DTD #16 activity.

Oil Lines (OL #30): Low and high-pressure hydraulic fluid lines. Additionally, air return lines attached to the OR #27. The bulk of these lines are contained in the HECR #2.

Nitrogen gas lines (N2L #31): Nitrogen gas is used in hydraulic accumulators on one side of a piston or inside of a bladder. High pressure oil is used to compresses this nitrogen gas to maintain a constant source of stored, high pressure hydraulic oil. The nitrogen gas is only used in the HECT #2.

Center Of Gravity (COG #32): The center of gravity is used as one point in a, “Length-in” reference point measurement, while the fulcrum #23 of the CC2ML #1 is the other reference point.

Portable Container (PC #33): A container that would provide the liquid environment so that the BGB-E could provide power for vehicles or any object that requires a transitory motion or a rotary motion such as to turn a propeller or a rotor in a generator or for any other decentralized power requirement.

BGB-Engine prototype #34: A BGB-Engine prototype is shown in FIG. 1-A and represents the starting position for the BGB-Engine power stroke.

Axles (#35): Each BV or GV is mounted on wheels which subsequently require axles to accommodate the differential displacement requirements established during the application of the DTD #16 activity.

Designed in Proximity Alignment (DPA #36): Highlights the importance of maintaining the spacing between each BV and also to the spacing between each GV, while maintaining their total independence. A chain like connector CLC #39 may be placed around each of their respective axles to maintain this minimal separation condition. The connection CLC #39 is slightly oversized for the axle's diameter, so that each BV or GV can move vertically or rotate freely while maintaining a fixed position. The important interaction in this case is to maintain a condition of MRE #15 between the BVs and GVs wherever possible, and for as long as possible, during the application of the DTD #16 activity.

Wheels (#37): Each BV #17 and each GV #18, contain two wheels #37 which have the capability, to support their respective loads. They can also accommodate the holes placed into the tracks #38 plus, allow the axle's #35 to rotate while the wheels remain motionless. These wheels are mounted to rotatable axle's #35 which are attached to each BV #17 and each GV #18 which are supported by their respective tracks #35, which are positioned on the interior structure of the CC2ML #1.

Track (#38): An upper and lower track is required in order to accommodate the rolling action of the BVs #17 and GVs #18. These tracks #38 should contain holes to allow a liquid to easily flow through them.

Chain Like Connector (CLC #39): A chain like connector may be placed around each axle #35 attached to each BV #17 and GV #18 so that these BVs #17 and GVs #18 can rotate freely and move vertically without being restrained, while simultaneously, lines of BVs and lines of GVs can be independently pulled, using the DTD #16 activity.

Center Of Buoyancy (COB #40): The COB #40 is used as one point in a, “Length-in” reference point measurement, while the fulcrum #23 of the CC2ML #1 is the other reference point.

In Ground Container (IGC #41): An in-ground, elongated and narrow container adapted to accommodate one BGB-E whereby this open top tank with a specific number of length segments, of a steel grill cover assembly. These segments could be easily removed to reveal the entire open top portion of the tank. Therefore, the entire, assembled BGB-E can be lifted using a crane and lowered into the tank. A Base Locator (BL #47) is permanently attached at each side of the (longitudinal midpoint region) of the container's interior floor elevation. The BL #47 may be used to automatically locate and position the bottom extended fulcrum region of the CC2ML #1. The use of this technique allows the BGB-E to be fully assembled and lowered into the container with all of the BVs #17 and all of the GVs #18 in the neutralized position. The bottom extended region of the Fulcrum, is inserted into the BL #47 whereby it automatically and exactly positions the overall longitudinal length of the BGB-E inside the container. The top extended region of the fulcrum is attached to the horizontal top surface of the container. The use of this technique provides for the direct insertion and retraction of a BGB-E from any useful height, narrow-width and extended length container.

Sealed Bearing Insert (SBI #42): Both BVs #17 and GVs #18 may utilize the SBI #42, attached to the top and bottom surface thereof. A short length axle #35 with, in certain embodiments, a 0.75-inch diameter, may be inserted into the open end of the doubled SBI #42. A wheel #37 with an integral full-sleeve bearing may be fitted over the axle #35. The use of this technique allows each BV #17 or each GV #18 to continuously and automatically seek their respective COB or COG, respectively, while remaining in a fixed position on the CC2MI #1 during their SGPS #5, or while the BV′ #17 and GVs #18 are being displaced to a new position using the DTD #16 activity.

Pulleys Using Plastic Coated Wire Rope (PCWR #43): Standard pulleys are mounted on precision slotted axle's using a key locking mechanism to fix their positions along the axle #35 rod, utilize PCWR #43 whereby one end of the PCWR #43 is attached to the open end of the piston rod of either HA #6, HA #7, HA #8, or HA #9. The opposite end of the PCWR #43 is passed through a series of pulleys and is attached to the chain-like-connectors, attached each side of the last BV or the last GV in each of their respective lines. The single ended, double acting, linear HA #6-HA #9, apply a pull force to each line of BVs or to each line of GVs using a specific process to displace these vessels in accordance with the requirements of the DTD #16 activity. These HAs may be powered with high pressure hydraulic fluid that is stored in the HPHA #11 and its storage is continuously maintained every time a SGPS #5 is being operated. They can also be replaced with small capacity HM if desired.

End Clevis Assembly (ECA #44): Attached to each end of the BGB-E. They provide easy maintenance, removal, and replacement.

Miniature Working Model (MWM #45): Test results to answer questions and to verify results, conduct actual tests, guidance for future design, reverse engineered the power stroke of the BGB-E to demonstrate the equality between directly measured data and calculated data and many other applications.

Moment-Arm (MA #46): A measurement of the distance from the Fulcrum #23 to the center line of the BVs #17 force or the center line of the GV's #18 force, as these forces are placed into their respective SAP #21 on the CC2MI #1.

Base Locator (BL #47): The BL #47 are essentially feet for the legs of the ESS #48. They include an open area with three sides surrounding and are fastened to the inside bottom surface of a containment vessel at both sides of its longitudinal midpoint. The BL #47 provide for the insertion of a support rod or square channel or rectangular channel which is representative of the base configuration of the extended support system of the ESS #48. The BL #47 is designed to automatically locate the ESS #48 at its longitudinal mid-point location inside of a containment vessel with nothing more, than providing a fixed insertion point or a retraction point that automatically provides this positioning capability.

Extended Support System (ESS #48): An ESS #48 is used to provide for the direct insertion and retraction of a fully prepped BGB-E in its fully neutral condition, into and from any container vessel that houses the BGB-E. The assembly utilizes two BLs #47, which are attached directly to the bottom inner floor and are located on each side the containment vessel at the fulcrum #23 region of the CC2ML #1. On each side of this assembly at its vertical midpoint, are double SBI #42 which are aligned with another set of identical SBI #42 which are attached to each side of the CC2ML #1 at its vertical midpoint so as to be in direct alignment with the SBI #42 attached to the extended support system ESS #48. A precision pivot rod may be inserted into these SBI #42 which all have an adjustable, alignment capability. These SBIs #42 along with the entire ESS #48 may be pre-assembled prior to their insertion into the containment vessel. Once the BGB-E is inserted into the containment vessel and its bottom base is aligned and inserted into the previously positioned BL #47. At this point, the top positioning bracket which is located on each side of the top surface of the ESS #48 is bolted to the top horizontal lip attached to each side of the containment vessel at this longitudinal midpoint location. High and low-pressure hydraulic fluid hoses are located on all four sides of the ESS #48 and are brought to the surface at this longitudinal mid-point region of the BGB-E. The design to be used to transfer these hydraulic fluid lines from this point, to the HECR #2 will be “installation independently”.

Generally, a method of using the present invention includes the following. A user provides a BGB-E utilizing the CC2ML submerged in a static water source. This submerged BGB-E generates power from the use of the OPES of GVs and BVs, which are interactive with, and physically bound by, the established principals of MRE. In this case, the polarity of the BV and GV torques are equal in magnitude but opposite in direction which when summed together equal zero. Therefore, these OPES can then be easily displaced into specific locations on the CC2ML. Specifically, these locations are identified as SAPs. Using the DTD activity technique, are spaced apart and uniquely positioned into their respective SAPs, whereby they are now free from the conditions of MRE, and where they generate torques based on their new “set of conditions”. As a result, the totally independent energy sources of BV and GV can now develop torques commensurate with their new position on the CC2ML.

It is important to note that the magnitude of the force capability which existed for each of the BVs and for each of the GVs at the time they are positioned into their respective SAP positions will always remain at the same magnitude. In the BGB-E, only the torques change, not the initial force capability of the OPES.

The OPES uses (1) their respective original forces plus (2) their respective displaced mass and physical mass plus their (3) new respective positions on the CC2ML to establish torques as their new position has automatically established their respective (4) Moment-Arm MA for each BV and each GV while fulfilling the requirement of the second set of DTD activity conditions.

The resulting torques generated by each of the OPES yield identical polarity values which in accordance with convention and the rules associated with torques, automatically makes the torques additive. The BGB-E then releases the CC2ML from its locked position utilizing power actuators PAs so that the independent OPES immediately start to change to kinetic energy while they simultaneously, perform mechanical work and power during the application of the simultaneously generated power stroke, SGPS.

Typically, the SAPs are adjacent the opposing ends of the CC2ML, where the BV are positioned on one end, whereas GVs are positioned on the opposite end. These two OPES switch positions from their respective positions, following each application of a SGPS by way of the DTD activity. However, for a given SGPS, each of the BVs in the SAP will yield a line of action for its torques, which in turn is based on the BV's source of energy response, to the specific set of conditions represented at its specific position on the CC2ML. Simultaneously, the GVs will yield a line of action for their torques which is representative of its specific position on the CC2ML. Although, both the BVs and the GV's switch positions after each power stroke, the polarity of their torques will also change accordingly. However, in all cases, the torques generated by the BVs and GVs sources of energy will always yield the same polarity which automatically makes their torque's additive.

The OPES, of buoyancy and of gravity, simultaneously use their force of displacement (buoyancy) or their weight/force of (gravity) in conjunction with each of their respective SAPs on the CC2ML, to generate power. The power generation is through utilizing the OPES as sources of torques as their SAPs automatically allows their inherent forces to interact with their new position on the CC2ML which also, automatically provides the moment-arm for the torques being established. Therefore, both of these sources of potential energy now respond to their new position where they automatically and simultaneously change their potential energy capability to a kinetic energy condition. Their respective kinetic energy conditions are immediately applied to their respective torques, which their SAPs have automatically established for them. However, each torque must meet certain requirements in order to perform the task of a torque. A torque must have a well-defined “line of action” so that its direction can be identified in order to allow a polarity value to be assigned to it. The rule for torques with respect to polarity is: a torque's line of action that tends to produce a clockwise rotation is identified as a being negative and a torque whose line of action tends to produce a counterclockwise rotation is considered positive. The rule for an equilibrium condition to be established states that the summation of torques with opposite polarity values and which have the same net force/torque will be equal to zero and that these torques will be in a state of MRE. However, if the torque's polarity results are the same, the summation of these torques will be additive. In this case, the line of action from the BV's torque is upward which is clockwise which yields a negative polarity. Simultaneously, the line of action from the GV torque is downward which is also clockwise and is also a negative polarity. Therefore, the summation of these two totally independent torques are additive and in this case the summation of the two negative polarity values shows the output of the buoyancy and gravity torques will be additive (Torque Force).

Another requirement for torques is that the forces that generate the torques must be non-concurrent which means, the line of action that is generated by each force do not intersect. In this case, the non-concurrent condition identified for the lines of action for the buoyancy force and also the line of action for the gravitational force are positioned such, so that each of their respective line of action will never intersect (Supporting Force #1).

Another interaction that occurs at this particular time, deals directly with the line of action resulting from the forces of buoyancy and the force of gravity, which also has a respective line of action, pass through the respective center of buoyancy and respective center of gravity. These forces will automatically accelerate the objects, which in this case, are the SAPs on the CC2ML, in the directions of the forces line of action being applied. This action is identified as (Supporting Force #2). As one can see (Supporting Force #2) and (Supporting Force #1) will provide additional force generated support for the torque generated rotational force (Torque Force). All of the three forces identified, occur simultaneously and all have one purpose which is additive which when summed together will cause the rotation of the CC2ML at its fulcrum point and also at its force application locations. At this point the BGB-E is ready to generate its SGPS.

It is important to note that the measured end point of the SGPS in this case is synonymous with the pre-programmed end point established in the BGB-E. The fact that the BGB-E utilizes radial displacements for the power stroke, automatically necessitates the establishment of limits for the maximum displacement allowable for a specific BGB-E. Therefore, this limit is pre-selected to occur at the end point of the SGPS. It is important to note that the physical forces and weights which the OPES inherently contain do not become diminished in any manner with respect to their specific contribution to the development of the SGPS. The resulting action from the application of the torques generated by the OPES, causing the CC2ML to rotate about its fulcrum's axis in the direction identified by these torques and in accordance with their respective torques polarity plus the contribution of the forces identified as (Supporting Force #1) and (Supporting Force #2) which are associated and summed along with the torque's being generated. The preselected radial distance limit developed from the BV, in certain embodiments, corresponds to a 60 degree change in the CC2ML orientation while simultaneously the GV also has a limit established which corresponds to a 60 degree radial change in the CC2ML orientation, which together with the BV's orientation's change, yields a summation of 120 degrees for the CC2ML total change in orientation. This is also known as the “work-in” portion of the BGB-E.

The methodology utilized to calculate the amount of “work-in” being generated from the OPES is as follows: a standard analytical model used for class II mechanical levers was used throughout this evaluation. The force value times the “length-in” value equals the torque value. The test values yield the following: 1,832 pounds of Buoyancy or Gravity (as each of the potential energy sources have exactly the same net force) force times a “length-in” value of 16 feet equals a torque value of 29,312 pound-feet. A distance of radial rotation for one side of the CC2ML powered by the torque value which in this case is 29,312 pound-feet times 16 feet of the CC2ML's radial rotation equals 468,992 pound-feet of “work-In” for one side of the CC2ML power-stroke. The opposite side of the CC2ML which represents either a BV or GV side, as both sources of energy yield exactly the same force value of 1832 pounds and have exactly the same length-in, value of 16 feet which yields exactly the same torque value of 29,312 pound-feet. Therefore, the torque value of 29,312 pound-feet has also caused the simultaneous radial rotation of the CC2ML through a distance of 16 feet.

These two energy sources, subsequently and simultaneously, each cause a radial rotational-displacement of 16 feet plus each energy source causes a 60-degree change in the CC2ML orientation. Therefore, these changes caused the orientation of the CC2ML to change 120 degrees from its pre-power-stroke position occurs at the end of the SGPS and is synonymous with a preset limit in the BGB-E. In other words, the limit established in the BGB-E is based on its initial, physical dimensions which automatically dictate a maximum value of displacement for a given BGB-E.

Following the completion of the SGPS, DTD activity is used to displace the two active sources of energy back to their respective neutral position on the CC2ML where another capability in the BGB-E is identified as MRE is operational. This activity is utilized to maintain a condition of mutual rotational equilibrium for the other sources of potential energy which are exact replicas of the two active sources of energy. All of these replicas have the exact same net force and the BGB-E has a sufficient number of buoyancy (BV) and gravitational (GV) sources of energy in the proper configuration so that they can rotate in a prescribed manner to maintain a continual replacement of active OPES. As can be seen in the data presented herein, the amount of work required to perform the DTD activity, was 0.00217 percent of the total work value of 937,984 pound-feet generated, which means 100 percent minus 0.00217 percent yields a value of 99.99783 efficiency. The fact that the energy utilized for the operation of the DTD activity is obtained from the output of each SGPS, which always precedes the application of the DTD activity, makes the efficiency number approach the 100 percent value.

Concurrently, during the application of the SGPS, the piston-rods of single ended linear, double-acting, power actuators (PA) attached to each side of the compound class-II mechanical levers CC2ML, are displaced by the simultaneous mechanical action of the CC2ML upward and downward power strokes. This action pushes or pulls the trapped hydraulic fluid inside the hydraulic actuators (HAs) and displaces it out of and into, standard high-pressure hydraulic accumulators (HPHA) and in certain embodiments, between 2500 and 3500 psi. The high mechanical forces resulting from the Mechanical Advantage (MA), developed by each SGPS, are used to exchange these mechanical forces into hydraulic energy using the PAs just mentioned. In this case, each HA may be used as “silent” high pressure hydraulic, linear-pumps rather than sources of high force. It is important to note that the data being referenced in this specific document is based on the BGB-E prototype design #34 and that the data may vary slightly from that being stated.

The instant that the SGPS is completed, the DTD positioned in the SPAs, (in certain embodiments may be two sets of BVs and two sets of GVs are different/ally displaced a distance of (˜12 in to 24 inches) back to their respective positions of MRE. The DTD activity, now differentially displaces selected OPES to a maximum distance of 12 inches to 24 inches into the empty SAPs. However, as mentioned earlier, these OPES are now positioned in opposite locations from that utilized in its prior operation. The utilization of this sequential technique in the DTD activity importantly differentially repositions the OPES over a very short distance to yield a desired condition that directly and simultaneously re-establishes the configuration of the CC2ML to the new condition which is required for the development of a SGPS. The DTD has now fully completed its activity. It is important to note the source of energy which is used to provide all of the OTO displacement work is obtained from the hydraulic fluid pressure being generated during the SGPS and is simultaneously stored in the HPHAs, during this time period. It is also Important to note, that the total output of work obtained from the HPHAs to perform the entire DTD application for this prototype test is 2,035 foot-pounds.

The energy utilized for the operation of the DTD activity is obtained from the output of each SGPS which always precedes the application of the DTD activity, making the efficiency number approach the 100 percent value. Furthermore, the utilization of another source of potential energy ASPE, is also readily available for any purpose, in that the hydraulic accumulator storage capability is fully integrated into the design of the BGB-E. This is just another source of potential energy (PE) which the BGB-E can utilize to perform any activity it may need, and also provides support for the two OPES which are fully integrated components in the BGB-E.

Subsequently, the respective torques of the selected buoyancy and gravity sources of energy yield identical polarity values which means their torques are additive. Therefore, the CC2ML is freed from its locked condition so that it can start the Follow-On Simultaneously Generated Power Stroke (FO-SGPS).

The BGB-E is adapted to continually generate power without the need for additional external inputs because it does not change its initial sources of energy in any manner, and therefore the BGB-E will never need to be refueled. Its source of energy becomes useful only due to its physical position in the BGB-E and its useful position is continuously being reestablished. Therefore, these sources of energy of buoyancy and gravity are available to generate each power stroke as it is made available. The BGB-E can generate totally free, decentralized power verses the expected, Fusion's centralized power.

Other important factors that contribute to the operation of a BGB-E is its limitless scalability, plus its ability to utilize the MA value associated with a compound class-II mechanical lever plus its utilization of the MA value which is associated with an IP, whereby both of these MA values are utilized twice during each simultaneously generated power stroke SGPS of the BGB-E.

The BGB-E utilizes the CC2ML system which is fitted with, single ended, double acting, linear, HPHA which automatically utilize the high-level mechanical forces generated by the action of the CC2ML as the driving force to output 3000 psi high pressure hydraulic fluid which is simultaneously urged in to the HPHA. This action is continuously on-going during each SGPS. The BGB-E can simultaneously, perform two independent power strokes SGPS utilizing the CC2ML which contains two levels, whereby a series of completely independent BVs are positioned on the upper level and a series of completely independent GVs are positioned on the CC2ML's lower level, see FIGS. 1A through 1E. The BV and GV are potential or kinetic OPES which have been incorporated into the BGB-E such that they interact with each other in multiple ways. One such manner is they cause the partial rotation or (a simultaneously generated power stroke SGPS) of the CC2ML whereby their respective buoyancy forces and respective gravitational forces operate to do work which is 180 degrees out of phase with respect to each other. The amount of power which the BVs generate during the upward portion of the SGPS is added to the amount of power being generated by the GVs during the downward portion of the same SGPS. It is important to note that the BGB-E's power generation capability is highly unique as it embodies two completely separate and totally independent OPES that each “B” and “G” vessel provides during their respective but simultaneous power strokes. The power generated from each “B” or “G” vessel provides a continuous force over the entire time period of its simultaneous power stroke application and it does not create thermodynamic issues as many other operators of power generators experience which utilize an energy source to provide a few milliseconds of power pulses to rotate their generators.

The BGB-E also has a target operational frequency of 20 power strokes SGPS per minute. However, in order to continue to generate a second power stroke and also to provide a continuous power generation capability, it is necessary to include other features into the BGB-E. These features involve the simultaneous establishment of a DTD activity along with the utilization and establishment of the principals of MRE. High pressure hydraulic fluid which is established during the operation of the SGPS by the action of the high mechanical force being generated by the CC2ML, reference FIG. 1A, which is used to apply a push or pull force to the piston rod ends of high-pressure hydraulic actuators PA which outputs high-pressure hydraulic fluid. This high-pressure hydraulic fluid is continuously generated during every SGPS and is immediately urged into standard high-pressure hydraulic accumulators HPHA, as it is being generated. This stored high pressure hydraulic fluid can also be directed to a hydraulic motor (HM), which can simultaneously provide the driving force for the operation of an electric alternator EA, whereby its electrical output can then be directed to any of its intended locations using a standard sub-surface electrical power distribution system SSSEPDS. In that the BGB-E is based on the idea of being totally decentralized, this type of standard sub-surface electrical power distribution system SSSEPDS will further support one of its important parameter's which is to make the BGB-E's operations impervious to the climatic changes that occur in its service area. A small portion of this stored potential energy can also be used to provide a pull force to the four 24-inch stroke, single ended, double acting, linear hydraulic actuators HAs. These HAs may be utilized to position and to reposition the BVs and GVs on the CC2ML during the application of DTD activity and to establish and utilize the principals of MRE which are simultaneously on going during this period. The new positions established for each of the totally independent BVs and GVs by the action of the DTD activity and MRE capability is sufficient to enable the BVs and GVs to continuously generate a follow on simultaneously generated power stroke (FO-SGPS). The action of the FO-SGPS brings the mounted BVs and GVs back to their initial starting position. At this point, the DTD activity, combined with the MRE capability has been applied, however its action is applied in the reversed manner from that applied during its “preceding application”.

As mentioned above, the BGB-E has the inherent capability to store a limited amount of 3000 psi hydraulic fluid, which subsequently provides another source of potential energy which is continuously “generated and stored”, during the operation of each SGPS and this source of hydraulic power is immediately available for use during the generation of the first SGPS and all SGPS's there-after. A single SGPS produces 99.99 percent more power than the power required for the application of the DTD activity and the MRE capability for both the BVs and GVs. Therefore, the OPES being utilized throughout the operation of the BGB-E are further enhanced, with the “added capability of another source of potential energy to the BGB-E”.

The CC2ML contains two elevations, see FIG. 1A, the top elevation is populated with totally independent, identical size BVs which each have the same net force, whereas the lower elevation contains totally independent GVs, or groups of independent GVs which are divided into smaller volume containers to better accommodate the weigh factor and to minimize the unwanted buoyancy factor in the GV design. Therefore, each GV or group of GVs as is shown in FIG. 1A through 1E, has the same net force which is exactly equal but opposite to the net force of the BV's. The fully independent BVs and GVs are exactly positioned on the CC2ML such that each BV has its center line of buoyancy force aligned with each GV or group of GVs, center line of gravitational force. Additionally, each GV or group of GV's is located in the same vertical plane as its respective BV. All of the BV's and GV's centers of force, are positioned such so as to be perpendicular to the longitudinal axis of the CC2ML.

Each of the BVs and the GVs which are positioned on the CC2ML are assigned a plus or minus sign which represents the direction of the line of action of the torque being generated by each of these B or G vessels. A torque that tends to produce a counterclockwise rotation, as referenced to the class-II lever, is considered positive and a torque that tends to produce a clockwise rotation to the CC2ML is considered negative. Therefore, the requirement for a body to be in the state of MRE is as follows; the sum of the torques acting upon a body about any point, using the convention for plus and minus signs must be zero”. Consequently, a BV positioned directly on the upper elevation and on the left side of the class-II lever's fulcrum has a GV positioned, or a group of GVs located in the exact same position also on the left side of the CC2ML's fulcrum, but is located on the lower elevation. Both the BV and GV are positioned on the class-II lever at the same distance from the fulcrum of lever CC2ML. In this specific example, both the BV and GV are located on the “left side” of the CC2ML. Therefore, we can also state that each of the BVs and GVs or a group of GVs that, perform as a group, have equal net force's, which automatically means that their torque values (force times the distance from the lever's fulcrum equals torque in foot-pounds) are identical.

The line of action of the BV's torque in this case, wants to move in the upward direction which is clockwise as referenced to the CC2ML and we can therefore assign a negative value to this torque. However, the GV or GV group wants to move in the downward direction which is a counter clockwise direction as referenced to the CC2ML, so we can now assign a positive polarity value to the GV's torque. One can see that the summation of the torque's resulting from both the BV and the GV is equal to zero. The BV and GV which are the recipients of these specific conditions are now in a state of MRE. In the BGB-E, if a differential translational displacement DTD activity “has not been initiated” between the BVs and GVs (i.e.,=to the start-up condition) all of the BVs and all of the GVs mounted on the CC2ML will have had a polarity value assigned to their torque's line of action in accordance with the convention identified in the example above. An additional requirement for a state of MRE to be applicable at the start-up of the BGB-E, the line of action from the torques being generated by each set (pair's) of BVs and GVs that occupy the same vertical location and the same distance from the fulcrum, as they are positioned on the CC2ML, should have their torque's vertically aligned, but opposite in direction, which will yield a summation value which is equal to zero in accordance with the requirement stated above.

One of the parameters which establishes the overall power output of the class-II lever CC2ML in the BGB-E's prototype design is the number of BV's which are displaced to the selected SAP on the upper level of the CC2ML, plus an equivalent number of GVs, which are simultaneously being differentially displaced to the selected SAP on the lower level of the CC2ML. Following the start-up of the BGB-E's prototype design, four BVs are differentially displaced to the selected SAP locations which are positioned on the far-left side of the CC2ML. These BVs are positioned on the two adjacent lines of BVs, thereby occupying the last two longitudinal positions on the upper elevation of the CC2ML's “left side”. Simultaneously, four GVs, or a representative group of GV's which in some cases is selected so as to more easily accommodate the weight factor, are differentially displaced to the selected stand-alone positions located on the “far right side” of the CC2ML. These GVs are also positioned on the two adjacent lines of GVs thereby occupying the last two positions on the lower elevation of the CC2MLs “right side”. Under these conditions, the line of action for the BVs torque for each of the BVs located in their respective stand-alone positions SAP, are clockwise (negative) values. The line of action for the GVs torque for each of the GVs positioned in their respective SAPs is also clockwise. Therefore, each of their torque values are negative whereby the summation of the two negative torque values obtained from each of the BVs and each of the GVs are additive. The upward buoyancy force/torque is applied to the CC2ML at the four BVs COB, meanwhile on the opposite end and lower elevation of the CC2ML, four GVs are simultaneously applying a downward gravitational force/torque at the COG, as referenced to the CC2ML. As mentioned earlier in this document, one can see that additional supporting conditions identified as (Supporting Force #1) and (Supporting Force #2) will provide additional “force generated” support for the torque generated rotational force (Torque Force). All of the three forces identified, occur simultaneously and all have one purpose which is additive which when summed together will cause, the rotation of the CC2MI at its fulcrum point and also at its force application locations. In the BGB-E's design, the forces which are being applied to the CC2ML are being produced by the OPES that are positioned in the SAP locations on the CC2ML and they collectively comprise a simultaneously generated power stroke SGPS, see FIG. 1E. A differential translational displacement DTD activity is repeated following each application of a SGPS, see FIG. 1D.

It is important to note that the slope of the CC2ML (which effectively is an Inclined Plane (IP) plus the application of the DTD activity, both have their directions reversed, after each SGPS is completed. These changing conditions automatically provide for the total displacement of the two lines of BVs, which includes both those BVs, which are positioned in their present SAP located on the far-left side of the CC2ML. All of the remaining BVs positioned in the two lines are now directly sharing each of their respective positions on the CC2ML with the two lines of GV's which have come from the BVs opposite direction, which resulted from the application of the prior DTD activity. Therefore, based on the specific conditions identified for each BV and GV earlier, as the respective lines of GVs and the respective lines of BVs are differentially displaced such that their new locations, automatically position each of the BVs to occupy the exact same vertical position on the CC2ML so as to be positioned in direct alignment with a GV positioned on the CC2ML's lower elevation. This condition will automatically cause the BV's and GV's which participate in this action to be in the state of MRE.

The new positions of the BVs and GVs resulted from the first, full application, of the differential translational displacement DTD activity. Concurrently, the far-left side of the CC2ML is positioned at its peak elevation point and the BVs which are positioned in the SAP on this far left side of the CC2ML, see FIG. 1C, have just completed their upward, simultaneously generated power stroke, SGPS. Simultaneously, the far-right side of the CC2ML is now positioned at its minimum elevation point as the GVs positioned in the stand-alone positions at this far right location have just completed their downward SGPS, see FIG. 1C.

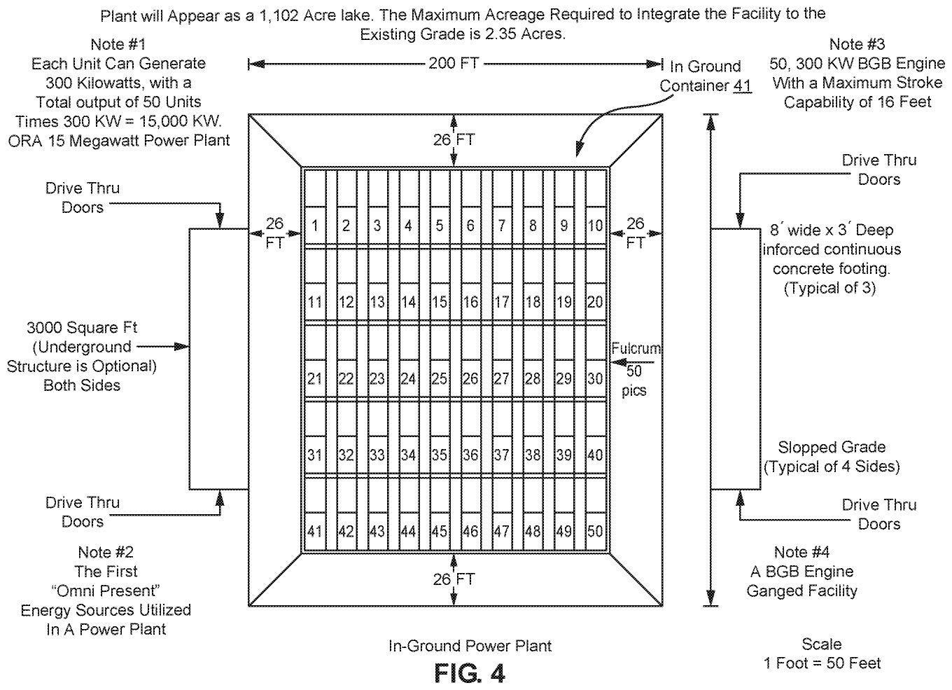

Obviously, the action of the OPES provided by the BVs and GVs act in a simultaneous manner and also in direct accordance with their torques, which when summed together comprise the total kinetic energy used to rotate the CC2ML at its fulcrum point, through a distance of ˜3.1 feet in the upward direction and 3.1 feet in the downward direction, see FIG. 1C. The 3.1 feet of distance however, is only representative of the start-up stroke as the CC2ML is starting from its horizontal elevation and therefore has no prior operational history. The actual depth distance utilized during normal operations is 6.2 feet per side for the CC2ML. This depth limitation is imposed by the BGB-E's prototype which is mounted in a portable container (PC) which is positioned at the local grade elevation. This action, causes the rotational distance of the CC2ML during its SGPS to be reduced considerably thereby also reducing its power output proportionately. However, for standard operations, the BGB-E's design would normally be positioned in an in-ground container (IGC), see FIG. 4, whereby its normal depth requirement of 16 feet (plus 8 feet and minus 8 feet) per side of the CC2ML, could easily be accommodated.

It is important to understand that the start-up condition is the only exception as the DTD activity is required to be applied first to give direction to the first SGPS. It is also important to observe the changes made in the distribution of the BVs and GVs as shown in FIG. 1B as compared to the distribution shown in FIG. 1A. Single ended, double acting, linear, hydraulic power actuators (PA) are used during the exchange, of the high mechanical force being generated by the CC2ML, to high pressure (3000 psi) hydraulic fluid, during each SGPS of the BGB-E. The PA may be utilized to provide the locking and unlocking action of the CC2ML. Following the unlocking action of the CC2ML, the first one/half SGPS is initiated as is shown in FIG. 1C. At the completion of the first one/half SGPS, the second DTD activity is applied, as shown in FIG. 1D. The BGB-E's prototype is now ready to perform its, follow-on power stroke FO-SGPS, once the DTD #16 activity is completed and the class-II lever's CC2ML's locking action is removed by the action of the PAs whereby their flow control valves are switched from the closed position to the open condition see FIG. 1D. The utilization of the DTD activity will ensure that each new set of BVs and each new set of GVs that are being translated from their present position of MRE, to their respective stand-alone positions SAP, will be located at the exact same distance from the fulcrum of the CC2ML as the prior occupants of these locations.

The main difference being the BVs and GVs has now switched positions at these locations. The torque for each new BV and GV translated to their respective SAP will automatically be increased due to their increased distance from the CC2ML's fulcrum point, (compare the open-end positions on the CC2ML shown in FIG. 1A, with the condition shown in FIG. 1B). Therefore, in order for the above action to become effective, the CC2ML will initially be configured to include one “open position” per side in its initial design, as shown in FIG. 1A, which can therefore accommodate one set of BVs (2 BV units) and one set of GVs (2 GV units). The conditions and specifications, regarding these open positions, will be described later in this document.

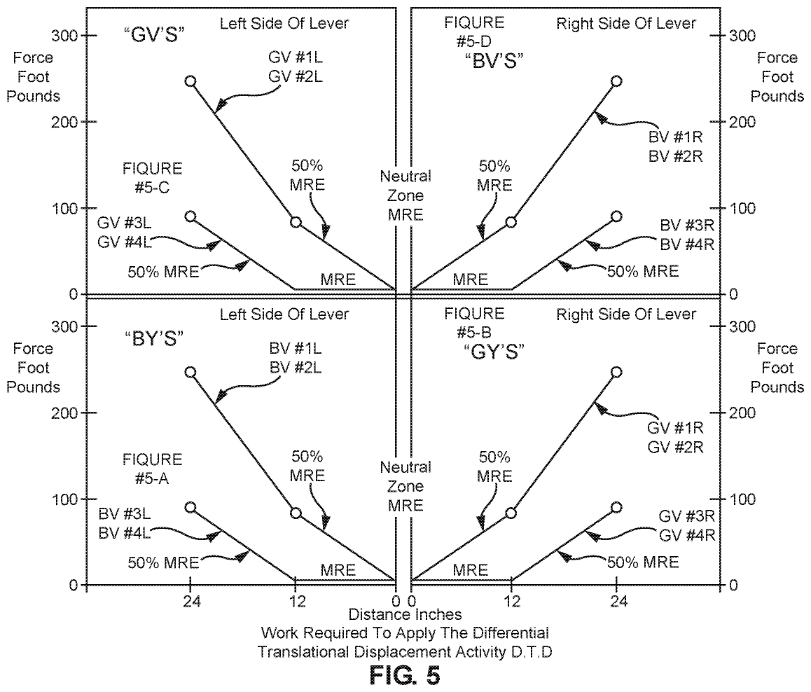

Therefore, using the standard convention for torques, a torque which tends to produce a clockwise rotation is considered to be negative and a torque which tends to produce a counter-clockwise rotation is considered to be positive as referenced to the CC2ML. It is important to note that each BV which is positioned on the CC2ML is considered to be a totally independent vessel with its own center of buoyancy. However, the GVs, due to a weight consideration may have individual groups of GVs which act as one unit which has its own COG as is shown in FIGS. 1A through 1E. Not only do these BV's and GV's have a torque relationship with the CC2ML, they also have a torque relationship between each other such as exists when these BVs and GVs are partially or completely in the state of plus they also have a torque relationship within themselves as referenced to their COB or to their COG which is manifested when they are positioned in the SAP. Subsequently, in the BGB-E's prototype design each BV and GV have had a torque analysis which shows a relationship that all of the torques within a given BV and GV set, cancel out at a point which is positioned at the midpoint of the bottom portion and top portion of each BV or GV cylindrical vessel. Based on this evaluation, the cylindrical vessels utilized for the BV's and GV's have axles positioned in like manner at these locations so as to be representative of the BVs and GVs, respective “centers of buoyancy” and “centers of gravity”. Those BVs and GVs which are being displaced but are not being displaced to a SAP during the application of the DTD activity, continue to maintain their original condition of MRE. This capability is provided by the originally designed-in, proximity alignment (DPA) condition, which automatically positions BVs and GVs located on their respective elevations on the CC2ML to be directly adjacent but not tangent to each other in the longitudinal direction. Each BV and GV can continuously rotate on their own axis thereby continually maintaining their respective centers of force, while stationed in a fixed position or can continuously maintain this capability while in the process of generating a power stroke or while the DTD activity is being applied. Each BV and GV is fitted with axles and wheels with sealed bearings which are attached to each side of these vessels at their respective centers of buoyancy or gravity. An upper and lower track is provided to accommodate the rolling motion of the wheels which are attached to each BV and GV which use is required during the application of the DTD activities. The upper and lower tracks also have a secondary purpose which is to prevent the BVs and GVs from floating off of the CC2ML when they are in the state of MRE which automatically makes these vessels, effectively weightless. A chain like connector is fitted to each BV or GVs axles which allows limited motion in the vertical direction and provides for the application of a pull force to each line of BVs or to each line of GV's in order to accommodate the minimal forward and backward longitudinal motion required in the BGB-E (see FIG. 5A through 5D). A second requirement for the use of the chain like connector is to maintain the minimal separation distance between each of the BVs located on the upper elevation of the CC2ML as well as to maintain the minimal separation of the GVs or groups of GVs located on the lower elevation of the CC2ML. Therefore, using this technique, each of the BVs and GVs can continue to maintain their complete independence while stationary or during the generation of a power stroke or while the DTD activity is being applied. In this case, the BVs and GVs can continually reestablish their condition of MRE using a simple sharing technique whereby adjacent lines of BVs share portions of their torque with the torque from adjacent lines of GVs which are located on the lower elevation of the CC2ML. This action is continuously on-going during the application of the DTD activity and its purpose is, to maintain the BVs and GVs in the state of MRE as long as the BVs or GVs involved in the sharing process are not being positioned in their respective SAP locations; however, as the DTD activity is on-going, BVs and GVs being repositioned to or from their SAPs will gradually lose their respective MRE condition or gradually gain a new MRE condition as is evidenced in the FIGS. 5A through 5D. These Figures show the instantaneous pull force that the BVs and GVs require as they are being displaced during the application of the DTD activities. Therefore, the instantaneous required force at any point during the DTD application is the sum of the represented data identified for a given displacement.

As mentioned earlier, the dimension of the “open positions” located at each end of the upper and lower elevations of the CC2ML, reference FIG. 1A, are initially established in accordance with the following schedule. The length dimension for these open spaces is determined using one-half of a BV's diameter which is being utilized in a specific BGB-E. This added space is required to be added to each end point on the CC2ML. Additionally, the second criteria states if the specific design of the BGB-E requires only one BV or one set of BVs to be located in the stand-alone position which are designed for a single BV unit or a set of BVs, then the length dimension of the initial open-space will be one/half of the BVs diameter. However, if the initial design requirement is to place two BVs or two sets of BVs into the SAP, the length dimension of the open-space will be equal to the diameter of the BV. Should the initial design require three BVs or three sets of BVs to be placed into the SAP, the length dimension of the open-space would equal to 1.5 times a BVs diameter.

During the application of the DTD activity, 2 BVs, or (one set) of BVs each with a diameter dimension of 24 inches, along with another set of BVs which yields a total of the 4 BVs, are being displaced to the stand-alone positions located on the far-left end side of the CC2ML. Using the established criteria for the “open-positions” stated above, the leading set of BVs is positioned in the stand-alone open-space position which in this case is 24 inches in length. The exact situation exists on the far-right side of the CC2ML, whereby the leading set of GV's is placed into the 24-inch length of open-space located on the lower elevation.

Normally, the magnitude of a displacement for this particular set of conditions would require a distance of 48 inches for the BV's and 48 inches of displacement for the GV's. However, the BGB-E contains a unique feature whereby all of displacement activity in the design, will always be applied differentially. This feature is identified as a DTD activity, which automatically, provides this capability. The utilization of this DTD activity in this particular case reduces the displacement distance required from the 48 inches identified above to 24 inches for the BV's and 24 inches for the GV's and yields a net savings of 50 percent in the work required to perform the DTD activity. This is a significant savings in the amount of work required following each power stroke of the BGB-E.

Obviously, without any other consideration to the “work required” for the application of the DTD activity to displace the BVs to their selected SAP has been reduced by 50 percent. Similarly, the “required work” for the displacement of the GVs is also reduced by 50 percent but its displacement direction is opposite to that utilized for the BVs. It appears that the displacement distances mentioned above were identified only for the BVs and GVs which are positioned in their respective stand-alone positions even though, all of the BVs and all of the GVs mounted on the CC2ML are experiencing the same differential displacements. However, it is a fact that all of the other BVs and GVs involved in the DTD activity remain in the state of MRE during the application of the DTD activity as each of their torques and net weights effectively are performing their tasks in accordance with the requirements to remain in the state of MRE. Therefore, these BVs and GVs are essentially floating and are not applying a net force to the CC2ML. Consequently, the forces being applied to the line of BVs and to the line of GVs undergoing the conditions of the DTD activity only directly affect those BVs or GVs that are “being positioned into or moving out of their respective SAP. One can obviously see that the utilization of the MRE parameter, along with the DTD activity yields a tremendous savings in the amount of work which would normally be required, during the application of the DTD activity and which in fact makes the BGB-E possible.

As can be seen, the DTD activity is utilized to displace selected BVs and selected GVs to their respective open SAP, which are located at the opposite end positions of the upper and lower elevations of the compound class-II mechanical Lever CC2ML. These BVs and GVs are initially in the state of MRE whereby paired BV's and GV's yield torque values which summation is equal to zero. However, as they are being differentially translated to their respective SAPs they will no longer be in the state of MRE and these BVs and GVs will immediately revert to the conditions commensurate with their original force condition which existed prior to their placement onto the CC2ML. Additionally, the BVs and the GVs each take-on new torque conditions which are imposed by each of their new position on the CC2ML.

It is necessary to consider another factor which is developed during the application of the DTD activity. In this case, the initial application of the DTD activity is first utilized at the start-up condition where all of the BV's and all of the GV's which are mounted on the CC2ML are in the full state of MRE, which is (the start-up condition whereby the CC2ML is positioned at its neutral, horizontal position) see FIG. 1A. Therefore, 50 percent of the normal DTD activity has been completed as the BGB-E is at its start-up condition. It is important to note, that at this point in the BGB-E's on-going operational sequence being applied for all BV's and all GV's are under the full control of MRE. Subsequently, the first application of the DTD activity will have a significantly different sequence to follow which is quite different from all of the follow-on applications of the DTD activity. In this case, the CC2ML is in the locked position as provided by the PAs.

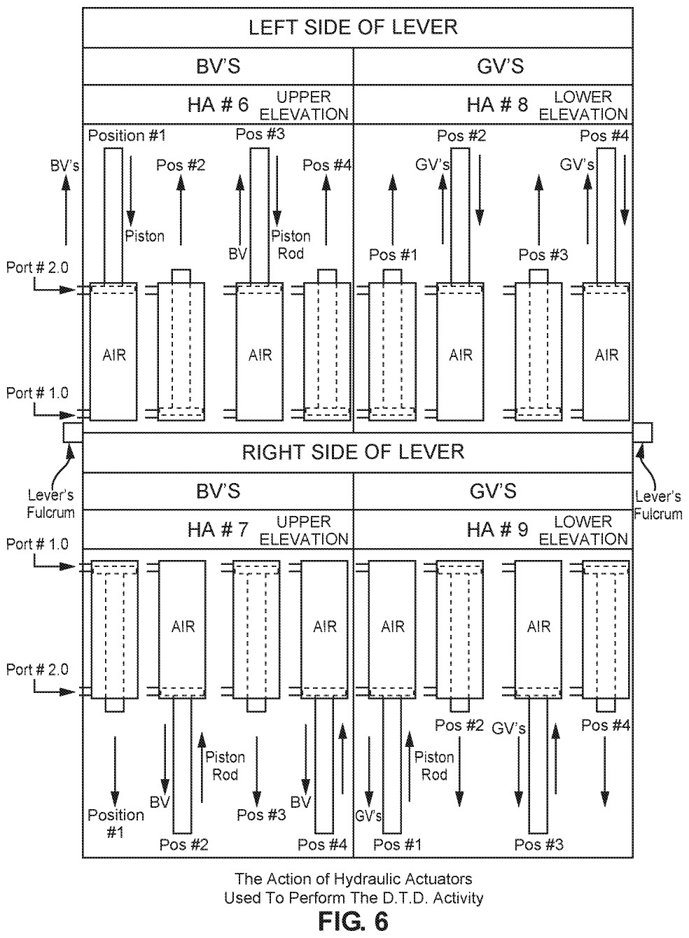

As can be seen in FIG. 6, the hydraulic actuators numbered HA #6 and HA #7 demonstrate the pull force to displace BV's as dictated by the DTD activity and are positioned such that HA #6 is extended to its maximum condition of 24 inches and that HA #7 is retracted to its minimum condition. These two HA continually interact with each other and they are positioned such so that they can respond immediately when the high-pressure hydraulic fluid from the HPHA is applied to the desired HA actuator's hydraulic port #2. However, in all cases, only one of the (HA #6 and HA #7) or one of (HA #8 and HA #9) hydraulic actuators is pressurized during each application of a given DTD #16 activity. Simultaneously, HA #8, and HA #9 are used to displace the GVs during the application of the DTD activity and at the start-up of the BGB-E, HA #8 is in the fully retracted (24 inch) condition and HA #9 is in the maximum extended (24 inch) condition. It is important to note, as the HA actuator's which are being pressurized, the mating actuator will always be pulled from its retracted position along with the lines of BV's or the lines of GVs, however, the case may be. At the start-up of the BGB-E, the CC2ML is in its locked condition and it is positioned at its neutral elevation, see FIG. 1A, its (horizontal position).

Instantaneously, high pressure, 3000 psi hydraulic fluid is obtained from the HPHAs and is applied to HA #6 and also to HA #9 which causes the lines of BV's to be displaced in accordance with the DTD activity so that 4 BVs are positioned in the SAP on the far-left side of the CC2ML. Concurrently, the pressurized HA #9 causes the lines of GV's to be displaced such that 4 GV's are displaced into the stand-alone position located on the far-right side of the CC2ML. As HA #9 is performing the displacement of the GV's in accordance with the requirements of the DTD activity, it also interacts with HA #8 by applying a pull force to HA #8's piston rod assembly thereby pulling it from its fully retracted position to its fully extended condition. This type of interrelationship is also on-going for HA #6, and HA #7, as it requires very little work to push unpressurized hydraulic fluid back to the hydraulic fluid reservoir while simultaneously pulling ambient air from the same hydraulic fluid reservoir and placing it into the bottom port identified as port #1 of HA #7 Obviously, when it is time for the mating actuator to be pressurized with 3000 psi hydraulic fluid from the HPHA, it will perform its work by applying the high pressure hydraulic fluid to its piston thereby pulling its piston rod inward along with the displacement of its respective lines of BV's or GV's. Simultaneously, this action will displace the air which is now located on the opposite side of its piston, back to the air portion of the hydraulic reservoir. At this point, the CC2ML is unlocked and OPES act jointly to complete of the first SGPS, see FIG. 1C. During the SGPS its output is simultaneously being processed through the CC2ML and through the power actuators PA's attached to the CC2ML which are used to exchange a high mechanical force to a high-pressure hydraulic fluid which is subsequently stored in HPHAs. At this point, the follow-on application of the DTD activity is being applied see FIG. 1D as the CC2ML is now locked in position with its far-left side at its peak elevation point and its minimum elevation point is positioned at its far-right location, see FIG. 1D. In order for the BGB-E to continue to operate, the DTD activity must now be applied.

The BVs and GVs have just completed their first partial SGPS and the CC2ML is positioned as stated above, see FIG. 1C. As the DTD activity is initiated, an interrelationship immediately develops between the instantaneous force of the BVs and GVs in their respective SAP and the force being applied to differentially displace these BVs and GVs from their respective SAP. These forces interact with each other as well as they interact with the condition of MRE. The graphical segments of this type of interrelationship are mentioned above and have previously been numbered and presented in FIG. 6, so as to develop a better understanding of this highly unique interrelationship. The general condition of the CC2ML is as indicated in FIG. 1C presented above. In this case, the selected BVs are positioned in the SAP on the left side of the CC2ML which is positioned at its maximum elevation point and the selected GVs are positioned in their respective SAP at the far-right side of the CC2ML which is positioned at its minimum elevation point. However, in the BGB-E's prototype design, the last two end positions located on the upper elevation contain 4 BVs (2BVs per position) and the last two end positions located on the lower elevation contain 4 GVs (2 GVs per lateral position). Normally, each set of BVs and GV's would operate independently. However, in the BGB-E's CC2ML, the torque's for all four BV's cause a clockwise rotation (a minus sign) as referenced to the CC2ML, whereas the torque from all four GV's also cause a clockwise rotation a (minus sign). One can see that in this case, the two individual sets of BV's and the two individual sets of GV's have lost their condition of MRE where the summation of their net torque values was equal to zero and due to the minor amount of differential translational displacement DTD, they have automatically increased their torque and also have changed the polarity of each of their respective torque value's to a minus condition. As a result of this change, the direction of the torque's line of action representing the four BVs and the four GVs located in their respective SAP, will all change to a minus (clockwise) condition. Therefore, the summation of the BV's and GV's torques which are represented in the stand-alone locations will now become additive.

Consequently, using the description for “force/torque-in” as is the standard convention used for mechanical levers, the actions just described above are representative of the (force-in) condition for the BVs which is located in the upper elevation's SAP which is located on the far left side of the CC2ML's fulcrum. Simultaneously, a representative (force-in) value is also developed for the GVs which are located in the lower elevation's which is located on the far-right side of the CC2ML's fulcrum. It is important to note that the remaining BV's and GV's which are located on the CC2ML in each of their respective position lines and elevations, also experience this same differential displacement. However, they all retain their status of MRE due their “designed-in proximity alignment” (DIPA), as it was originally established by the design of the BGB-E for the CC2ML. A complete review of the new conditions for each BV and GV, showed all the conditions for MRE continued to be fully effective for all of the BVs and GVs involved during the application of the differential translational displacement DTD activity, which do not occupy a stand-alone SAP position on the CC2ML. The significance of incorporating the principals of MRE into the BGB-E is it reduces the overall force required to complete the differential translational displacements DTD which are required to take place at the end of each power stroke of the BGB-E. The utilization of the principals of MRE make the design of the BGB-E not only possible but highly efficient when integrated into a design such as the BGB-E where essentially, all other operations are performed utilizing free OPES.

In order to minimize the width dimension of the 36-foot long CC2ML utilizing the BGB-E, the top elevation contains only BVs whereas the lower elevation contains only GVs. All of the inter-relationships between the BVs and the GV's remain as they have been identified, and the DTD activity will always simultaneously affect all BVs and all GVs, resulting in the simultaneous establishment of uniform SAP to develop at the opposite ends of both lines of BV's located on the upper level as well as an identical arrangement for the two lines of GV's located on the CC2ML lower level.

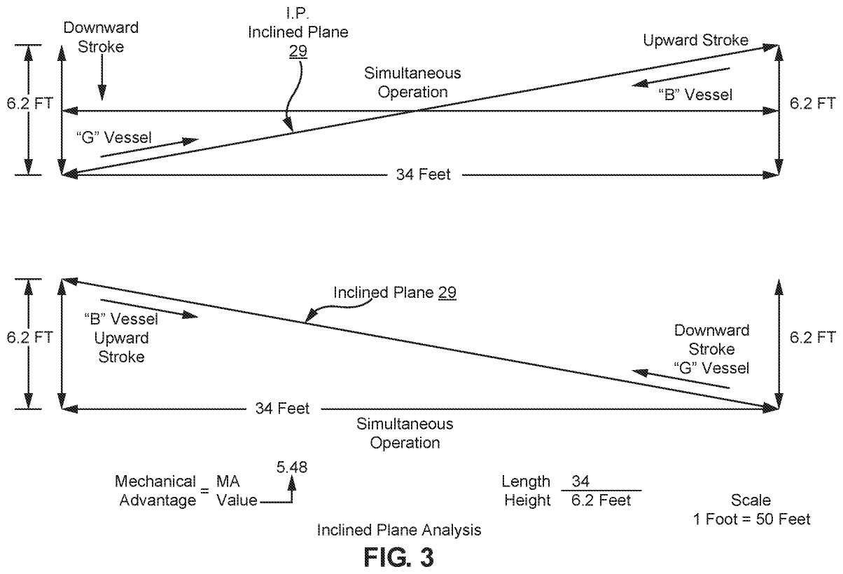

An additional parameter is also incorporated into the BGB-E which involves the differential translational displacement DTD activity of the BV's and GV's and its relationship to the power stroke of the BGB-E's design. In the BGB-E's prototype design, the required conditions for the actions cited above, will always be significantly affected by the slope of the CC2ML which is first established at its maximum clockwise rotational position, see FIG. 1C, and is subsequently reestablished at its maximum counterclockwise position, see FIG. 1E. The slope of the CC2ML can now be equated to an IP, wherein the rules for an IP are applicable. The MA of an IP is determined by the ratio of its lateral distance to its vertical height. In this case see FIG. 3, a value for the lateral distance is 34 feet, and its vertical height is 6.2 feet, which yields a MA value of 5.48. It is important to note that the torque portion of the “force-in” value established for the CC2ML includes two parameters. The first parameter is the net buoyancy force or net gravitational force and the second parameter is a distance from the fulcrum factor, and the product of these two parameters yields a representative torque value for either a “B”, or a “G” vessel. This torque value is utilized in the rotational analysis of the CC2ML. However, the utilization of the IP analysis only directly affects the net BV's force and the net GV's force and for only those BV's or GV's which are positioned in the SAP on the CC2ML. Subsequently, all of the pairs of BVs and GVs which are positioned such so as to be in the state of MRE during the application of the DTD activity will exhibit a torque summation force equal to zero and applying a 5.48 reduction factor to a zero value equals zero. However, the four BVs which are located in the SAP have a combined net upward Buoyancy force of 1,832 pounds which would normally require the application of a downward pull force of 1,832 pounds over a distance of 2 feet, in order to accommodate a repositioning displacement of the BVs in the downward direction, see FIG. 5. Simultaneously, the four GVs will also exhibit a combined upward gravitational force of 1,832 pounds over a distance of 2 feet which would normally require an applied upward pull force of 1,832 pounds to differentially displace the four GV's which have been positioned in the SAP located at the right side of the CC2ML. However, with the application of the MA value obtained from the IP analysis of 5.48 for the pull force automatically reduces the requirement for the applied downward pull force of 1,832 pounds for the BVs and the upward applied pull force of 1,832 pounds for the GVs, to decrease to a value of 338.29 pounds of pull force for each of the forces being applied to the BVs and GVs. This action only takes place after the four BVs have completed their upward power stroke and the four GV's have simultaneously completed their downward power stroke. At this point, the CC2ML is then automatically locked in place in accordance with the BGB-E's design. Even though the slope of the CC2ML changes direction at the end of each SGPS, it can continue to be analyzed as an IP as each change in direction yields the same result. The action of the CC2ML is a classical representation of an IP which provides a MA value of 5.48 to the force required for the on-going DTD activity performed in the BGB-E's prototype design, see FIG. 3. The application of this MA value of 5.48 significantly reduces the overall DTD force requirement for each stroke of the BGB-Es design. As mentioned, following each power stroke of the BGB-E's design, a DTD activity is required to reposition BVs and GVs into and out of the SAP on the CC2ML. This action also requires all of the BVs and GV's that are located on the CC2ML but are not located in a stand-alone position, to experience this same differential displacement which would normally require a significant amount of intra-stroke work. However, ninety five percent of the work just described is completely eliminated in the BGB-E's design as all of the BVs and GVs which are not being displaced into and out of the SAP are in the state of MRE whereby their torques are equal to zero. Therefore, all of these vessels will essentially be floating and will accommodate the DTD activity with little or no force requirement. Therefore, it can generally be stated that the “only work required” during the DTD activity, is the differential movement of the BVs and GVs “into” and “out of” their respective SAP. The sequence of events just described which utilize the significant benefits of an IP, effectively results in a significant reduction in the average net force required to transfer the BVs and GVs into and out of the SAP during the application of the DTD activities.

The DTD activity is then initiated so that the four BVs and the four GVs which are positioned in their respective stand-alone positions on the CC2ML, will require 334.3 pounds of force which is applied to the lines of BVs and also 334.3 pounds of force is applied to the lines of GVs using single ended, double acting, linear, HAs #6 through #9. The lines of BVs have the DTD activity applied simultaneously using the supplied downward pull force of 334.3 pounds, provided by its HA #6 which is positioned on the far-left side of the CC2ML see FIG. 6. HA #7 which is also utilized for the BV, is positioned on the far-right side of the CC2ML and it is in the fully retracted condition at this point. However, while HA #6 is in position #1, it is performing its pressurized duties it is also simultaneously positioning the piston rod of HA #7 to its maximum extended position, see HA #7, position 2. This action requires very little work as the volume of HA #6 which is not occupied by the piston rod has been filled with ambient air which was obtained initially from the air section of the hydraulic reservoir which also, provides a pathway for the ambient air to exit the HA #6 through its port #1 and subsequently return back to the reservoir. This statement is also applicable for HA #8 in position #1. As HA #9 in position #1 receives its high-pressure hydraulic fluid to simultaneously perform its duty cycle it also pulls HA #8 piston rod assembly shown in position #1, from its fully retracted position to its fully extended position, see HA #8, position #2. Concurrently, HA #7 in position #2 proceeds to perform a portion of the DTD activity in direct accordance with the requirements of the follow-on DTD activity as it applies to the BVs. This action requires HA #7 to displace the lines of B's from their far-left position on the CC2ML back to their neutral position. Simultaneously HA #6 in position #2 is automatically pulled from its fully contracted position to its maximum extended position. Simultaneously, HA #8 in position #2 is now pressurized to initiate a portion of the follow-on DTD activity for the GVs. This action pulls the lines of GV's from their far-right position to their neutral position and also pulls HA #9 in position #2 along with its piston rod assembly, from its maximum retracted position to its maximum extended condition: HA #9 in position #3, as shown in FIG. 6. HA #9 in position #3 is now ready to be pressurized in order to fulfill the final portion of the follow-on DTD activity requirement in accordance with the BGB-E's design. This action will complete the final segment of the follow-on DTD activity for the lines of GV's from the start-up (neutral) position and subsequently displace the last four GVs in the GV line-up into the stand-alone position located in far-left side of the CC2ML, see FIG. 1D. At this point, the DTD activity is complete and the CC2ML is ready to be unlocked so that the SGPS can begin, see FIG. 1E. It is important to note, that any time a HA actuator is pressurized it will perform its main purpose plus it will also automatically pull its mating HA actuator from its maximum retracted condition.

The actions of the hydraulic actuators HA #6 through #9, shown in FIG. 6. The data represent the start-up condition, whereby all of the BVs and GVs are in the state of MRE and the CC2ML is in a horizontal position, see FIG. 1A. Therefore, the data shown for the BVs and GVs represent the establishment of the first DTD activity and these data will only provide one half of a standard power stroke since it starts from the neutral position. Following this limited power stroke application, a second DTD activity is identified which is representative of all future follow-on DTD activities. It is important to remember that the DTD activity completely reverses its-procedure following each power stroke of the BGB-E.

The HA #6 and #7 are utilized to provide the forward and backward displacements of the BVs, are positioned on the top surface of the CC2ML whereas, the HA #8 and HA #9 are used for the GV's and are positioned on the bottom surface of the CC2ML. This action describes the results from an analysis of an IP whereby the MA value is factored into the overall analysis of the BGB-E along with the actions of the BVs and GVs which are required during the application of the differential translational displacement DTD activity. It is important to note that the hydraulic actuators mentioned in the above paragraph receive their hydraulic force from the high pressure 3000 psi hydraulic fluid which is being continuously generated during the operation of each SGPS and subsequently stored in hydraulic accumulator's HPHAs which is an integral part of the BGB-E. In order to be in position to immediately apply a pull force when required, these actuators have their piston rods, automatically fully extended and the end clevis assemblies which are attached to each piston rod, are directly attached to a chain like connector which is attached to the line of BVs and or GVs through each of their axles. The “chain like connector” CLC, contains a sealed bearing insert at its contact point with the interface of the axle, which allows each BV or GV to independently rotate about their own axis while stationary, or while the DTD activity is simultaneously being applied to their axles or when the SGPS is being performed. The linear hydraulic actuator's piston rods HA #6 through #9, are connected to the chain like connector CLC through a series of pulleys and plastic-coated wire rope #43. It is important to note for a given application of the DTD activity, only one hydraulic actuator is utilized at a given time period to apply 334.3 pounds of pull force to the lines of BVs and also only one hydraulic actuator is utilized at a given time period to apply the 334.3 pounds of pull force to the lines of GVs.

The following is a description of the action required during the start-up condition of the BGB-E's prototype whereby all of its BVs and GVs are in the state of MRE and the CC2ML is in the horizontal (neutral) condition, see FIG. 1A. Simultaneously, as high pressure is applied to HA #6 in position #1 pulls the lines of BV's from the neutral position and places the first four BV's in the SAP on the far left side of the CC2ML, it also simultaneously, pulls the hydraulic actuator HA #7 in position #1 which is located at the opposite end of the CC2ML from its fully retracted position of ˜24 inches to its maximum extended position along with the lines of BVs. HA #7 in position #2 is now ready to receive the high-pressure hydraulic force to accommodate the next segment of the DTD activity or is positioned for the follow-on DTD activity. An identical set of procedures is used for the hydraulic actuator HA #9 in position #1, which is assigned to the GVs. Obviously, the action which HA #6, and HA #7, are required perform for the BVs, is also applicable for the HA #8 and HA #9, which simultaneously requires this same action for the GV's. It is important to note that HA #8 and HA #9, that this action reverses for both the BV's and the GV's following each completion of the BGB-E's “simultaneously generated power stroke” SGPS. “In this start-up-case”, the piston rod assemblies from both HA #7 in position #2 and HA #8 in position #2 are simultaneously being pulled from their fully retracted position by the pulling action of HA #6 in position #1 and HA #9 in position #1. This action causes each of their respective pistons to suction the air that was originally obtained from the “ambient air” inside the hydraulic fluid reservoir #27, and to reuse this reservoir ambient air again to refill the volume of HA #7 and HA #8 that is not occupied by the piston rod, through each of their hydraulic port's identified as #1.

The sequences and activities just described are color coded yellow in FIG. 6. Simultaneously, “ambient pressure” hydraulic fluid from the reservoir's #27 sump will automatically be displaced back to the hydraulic fluid reservoir's sump through the opposite port (#2 port) located on the opposite ends of HA #7 and HA #8. At this point, the CC2ML is positioned at the horizontal position and the DTD #16 activity has been completed and the CC2ML is being unlocked from its neutral position. The CC2ML is now ready to complete its first one/half portion of a simultaneously generated power stroke SGPS. FIG. 1C shows the condition of the CC2ML after the start-up stroke has initially been completed. When activation is desired during the follow-on application of the DTD activity, HA #7 in position #2 and HA #8 in position #2 are now ready to receive a signal which will provide the 3000-psi high pressure hydraulic fluid which is obtained from the hydraulic accumulators HPHA to be placed into their respective #2 ports. The overall action described above is simultaneously applicable to both the BVs and GVs and requires very little work to perform this overall activity. It is now evident, that without any consideration to any other possible mitigating circumstances, the total amount of work required for the start-up condition is considerably less than that which will be required for all of the future applications of the DTD activity, while accommodating all of the follow-on SGPSs. This statement is primarily based on the fact that the BGB-E's starting point, has no prior history which needs to be removed before a new set of DTD activity instructions can be established.

Again, it is important to remember that each 12-inch segment of the application of the DTD activity requires 338.29 pounds of applied hydraulic force times a distance of 4 feet is required. However, due to the fact that the displacement is applied differentially, only a distance of 2 feet is required in this case. Therefore, to return the BVs and GVs to their original starting point, which is one half of the total DTD activity, a value of 334.29 foot-pounds of work is required for the DTD activity to displace the 2 sets of BV's a distance of ˜2 feet and simultaneously, the same exact amount of 334.29 foot-pounds of applied work is required to displace the 2 sets of GV's a distance of ˜2 feet. Therefore, the total amount of work performed for the operation of one half of the differential translational displacement activity DTD is 334.29 foot-pounds of work.

The completion of the DTD activity requires an additional 334.3 foot-pounds of work or a total requirement of 668.6 foot-pounds for each application of the DTD activity.

Obviously, these values will change slightly once the final design is established. The work generated during the follow-on SGPS, which is provided from the utilization of OPES 1832 pounds of buoyancy force times 16 feet of length-in which yields 29,312 foot-pounds of buoyancy torque times 6.2 feet of CC2ML upward rotation yields a work value for the “upward displacement for BV's” which equals 181,734.4 foot-pounds of work. Simultaneously, the same scenario is repeated for the downward portion of the simultaneously generated power-stroke SGPS, which is being generated by the OPES GV's, which yields a work input of 181,734.4 foot-pounds of work. Therefore, the total amount of work-input for the SGPS is 363,468.8 foot-pounds. Using the 668.6 foot-pounds of hydraulically applied displacement work and dividing this value by 363,468.8 foot-pounds of “input work” yields a value of 0.001840 percent. Based only on this evaluation, the BGB-E is 99.9981 efficient. However, the 668.8 foot-pounds of work being provided for the operation of the DTD activity, is obtained from the high-pressure hydraulic fluid which was previously obtained from the very first operation of the SGPS which was powered by the OPES, and subsequently stored in HPHA. The CC2ML generated a high mechanical force output which was applied to the hydraulic PAs, see FIG. 1C, which simultaneously generated high pressure hydraulic fluid at 3000 psi which was immediately placed in storage in HPHAs as potential energy for any present or future utilization. As can be seen in the above paragraphs, a small portion of this stored high-pressure hydraulic fluid is used to power the hydraulic actuators identified as HA #6 through #9.

At the initiation of the follow-on DTD activity see FIG. 1D it is important to note that those BVs and GVs which are positioned in their respective SAP at the start of the DTD activity, must first be returned to their initial start-up condition, and then be displaced in opposite directions to their new respective positions in accordance with the DTD activity. A comparison of CC2ML's condition presented in FIG. 1C with CC2ML's condition shown in FIG. 1D is a direct representation of the statements describing this action presented in the previous paragraph. As the first four BVs, which are located in the SAP on the far-left side of the CC2ML, immediately start to respond to the new DTD activity, they start to move from their stand-alone position. The GVs are also, simultaneously, moving from their stand-alone position and are moving toward the BVs. Consequently, the BVs start to develop a “proximity-interaction” with the GV's as the lines of BV's start to move into the proximity region of the GV's which are also moving into the proximity region of the BVs. The 4 BVs which are located at the far right-side position of the CC2ML but are not in the far right-side stand-alone position and the 4 GVs which are located at the far left-side position but are not in the far left-side stand-alone position, both, of these BVs and GV's continue to maintain their state of MRE utilizing a MRE sharing technique. This technique automatically involves GVs which are moving out from their far-right stand-alone position on the CC2ML and BVs moving out from the far-left stand-alone position on the CC2ML. The “instant” the DTD activity is initiated, the first pair of BVs and the first pair of GVs from each stand-alone position which is the closest to the CC2ML's fulcrum, will immediately start to reestablish a MRE relationship with the BVs or GVs which are positioned at the last position on the opposite end of each line of BVs or GVs. The BVs and GVs positioned at these specific locations have been in the state of MRE prior to the onset of the DTD activity. Therefore, at the “instant” the DTD activity is initiated, the pairs of BVs and pairs of GVs located at the end of each line of BVs or at the end of each line of GVs, start to lose their “existing mates”, the pair of BVs or the pair of GVs which are being displaced by the DTD activity, immediately replace any increment of space that the “existing mate” is giving up. It only requires 12 inches of DTD displacement activity before 50 percent of the all of the BV's and GVs originally positioned in the stand-alone position are now in the state of MRE whereby they no longer require a force for any further displacement. This rather complex series of interactions are graphically described and are quantified using the data provided in FIGS. 5A through 5D.

It is important to note, if either a BV or GV is being displaced from a condition of MRE into a position of SAP or is being displaced from a SAP location immediately into a region where MRE is active the inventor has applied a 50 percent reduction factor for the force required during these specific displacement transitions. Therefore, the data identified in in FIGS. 5A through 5D are effectively correct as the 50 percent correction factor has been previously applied and specifically identified as shown in the Figures.

As mentioned earlier, the differential translational displacement DTD, initiates at the end of each simultaneously generated power stroke SGPS which includes an upward BV generated force and a downward GV generated force SGPS. Both of these forces perform mechanical work simultaneously using the MA of a CC2ML. The mechanical work from each BV and GV is placed into single ended, double acting, linear, high pressure hydraulic actuators PA, which are positioned on opposite sides of the fulcrum #23 so that these power actuators can simultaneously, receive input work from both, the BVs and the GVs power stroke. At the end of the simultaneously generated power stroke, the CC2ML is locked in position by stopping the flow of hydraulic fluid into and out of the PAs. The CC2ML will remain in the locked position until the BV's and GV's which presently occupy the stand-alone positions have been repositioned to their prior-stroke position using the differential translational displacement methodology and the principals of MRE which have been established for that purpose. Therefore, with reference to the BGB-E's prototype design and also with reference to the starting point of the differential translational displacement period, the net force for the BV's which have just completed their upward power-stroke and which are located in the stand-alone position on the left side of the CC2ML which has two rows of 2 BV's each which have displaced four 55 gallon air filled containment vessels and when viewed collectively will yield a buoyancy force of 1832 pounds. This force of 1832 pounds is applied to the far left side of the CC2ML and at the COB, of these four BV's. This specific location is 16 feet from the fulcrum of the CC2ML. This distance is identified as the (“Length-in”). The length-in value of 16 feet times the “B” force of 1832 pounds is equal to 29,312 foot-pounds of torque which represents (the “force-in”) value. The direction of the BV's torque line of action is identified as upward which is a clockwise direction and therefore is assigned a negative value. The “force-in” value of 29,312 foot pounds of torque using the OPES of Buoyancy which is a derivative of the OPES source Gravity provides a value for the (“work-in”) by multiplying the 29,312 foot-pounds (force-in) torque times a rotational upward distance of 6.2 feet of clockwise power-stroke distance/height equals 181734.4 foot-pounds of “work-in”. The condition of the CC2ML at this point, is identical to the condition of the CC2ML shown in FIG. 1B and FIG. 1C except the stroke is 6.2 feet instead of 3.1 feet which is valid distance for the start-up stroke. The exactly same scenario is simultaneously developed for the G force which also yields 181,734 foot-pounds of “work-in”. Therefore, the sum of the “work-in” equals 363,468.8 foot-pounds of “total work input”. It is estimated that the time period for the SGPS to completely take place is one 1.5 seconds. Therefore, dividing 363,468.8 foot-pounds of “work-in” by 825 foot-pounds per 1.5 seconds which equals (one horsepower) yields a value of 440.56 horsepower or 328.77 kilowatts. These values represent the rate at which the “instantaneous power” is generated in the BGB-E. As mentioned, the total time estimated between the start-up of each SGPS's is 3 seconds which automatically suggests that an “estimated recovery period” is equal to ˜1.5 seconds which yields 20 simultaneously generated power strokes SGPS per minute. It is important to remember that the 20 power strokes per minute is an estimate. However, using the 20 strokes per minute value or three seconds per stroke yields an effective average value for horsepower using 363,468.8 foot-pounds of work per stroke, times, 20 strokes per minute equals 7,269,376 foot-pounds of work divided by 33,000 foot-pounds of work per minute equals 220.28 horsepower or 164.39 kilowatts of power. It is important to note that, the rate at which the work is actually being generated and the magnitude of the instantaneous force are the factors which governs the pressure level of the hydraulic fluid which is simultaneously generated. Also, since the high pressure hydraulic fluid is totally storable as potential energy, at the pressure level that it was originally established, it is believed that a more realistic value for the stored high pressure hydraulic fluid is 440.56 for HP and 328.77 kilowatts. Using this logic, the hydraulic accumulator only stores the high-pressure hydraulic fluid, at the rate and stress level which it was generated and it subsequently should be able to power a hydraulic motor which powers an electric alternator using the higher Horsepower and Kilowatt values.

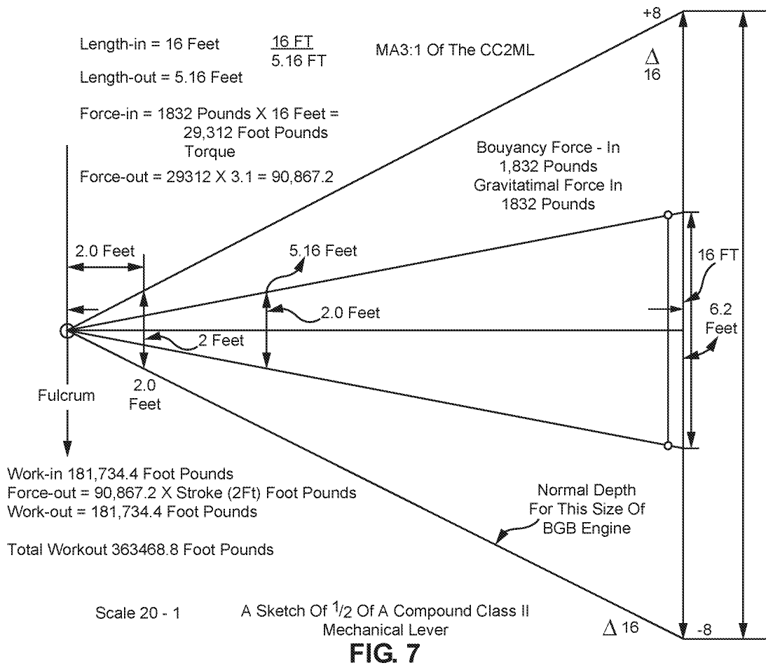

Additionally, another factor to consider is the BGB-E's prototype is limited to the 6.2 feet upward and 6.2 feet of downward rotation. The true capability of the Engine's prototype design is 16 feet upward and 16 feet downward. These changes affect the power output considerably. The torque value of 29,312 foot-pounds times 16 feet=468,992 foot-pounds times 2 (both sides of CC2ML) equals 937,984 foot-pounds of work divided by 825 foot-pounds in 1.5 seconds=1136.95HP and 848.41 kilowatts. It is easy to see that the 50 BGB-Engines of the BGB-E's prototype size, ganged together and referenced in FIG. 4, utilizing the 16 feet of upward and 16 feet of downward deflection, can produce a serious amount of power with little or very limited operating costs. Therefore, 848.41 kilowatts of power per total stroke output, in 1.5 seconds of time, for 50 units equals 42,420.5 kilowatts or 42.42 megawatts of electrical power. All of the parameters which are representative for the actual conditions presently being applied to the BGB-E's prototype design and which are represented on the CC2ML are presented in FIG. 7. The schematic shown in FIG. 7 represents one side of the CC2ML whereby 16 feet from the fulcrum represents the center of Buoyancy #40 or the center of Gravity #32 as the case may be, for the BV's or GV's which are alternately positioned at this specific location which represents the longitudinal midpoint of the four BV's or four GV's. As mentioned, this value of 16 feet is identified as the “Length-in” value. The “length-out” value is a variable which is determined by the selectable distance over which the “force-out” will be applied. In the BGB-E's prototype the inventor has selected a distance of “two feet” over which the “force-out” value will be applied. Subsequently, the location of this 2-foot distance is graphically shown in FIG. 7 and its “length-out” value is 5.16 feet from the fulcrum of the CC2ML. The next important parameter for a CC2ML is the ratio between the “length-in” and the “length-out”. As can be seen in the FIG. 7, this ratio is 16 feet divided by 5.16 feet which yields a value of 3.1 which is the value for the MA of the CC2ML. The MA value of 3.1 is multiplied times the “Force-in” torque value of 29,312 foot-pounds which yields a value for “force-out” of 90,867 foot-pounds of torque. In that the “force-out” value is applied over a distance of 2 feet, the “work-out” value is 90,867 foot-pounds times 2 feet of distance which equals 181,734.4 foot-pounds of work per side of the CC2ML. Referencing the data presented above, where the value for the “work-in” is identified as 181,734 foot-pounds of work, one can see this value is identical to the “work-out” value of 181,734 foot-pounds. Obviously, these data only represent 50 percent of the total amount of work being input as well as being output from the CC2ML being considered in the analysis presented in FIG. 7. Therefore, the total amount of “average-work-input” is 363,468 foot-pounds and the total amount of “average-work-output” from a given SGPS is 363,468 foot-pounds of work. This equality is in agreement with the law of Conservation of Energy which states the work completed on a machine by the “force-in” must exactly equal the work performed by the machine through the “output-force”. It is obvious that the BGB-E's prototype conforms to the Conservation of Energy law as stated above. The exchange of the mechanical “input work” which is simultaneously being generated from the power stroke of the CC2ML is accomplished utilizing the “output-force” from the CC2ML which is 90,867 foot-pounds of torque times the two-foot length of hydraulic actuators which are positioned on both sides of the CC2ML's fulcrum. In this case, the inventor has chosen to use production type-standard size, single ended, double acting, linear, hydraulic actuators for economic purposes with a combination of 3.5 inch and 4 inch bore hydraulic actuators with a combined average pressure of “‘3000 psi capability and a 24-inch stroke capability. These HA are identified as PAs whereby each group of PAs are attached to the CC2ML at a “length-out” distance, of 5.16 feet on each side of the CC2ML's fulcrum #23. These PA's have the capability to generate high pressure hydraulic fluid from the high-level mechanical “force-out” value of 90,867 foot-pounds of torque. As stated in the text and as shown in FIG. 7 this exchange of a mechanical force to a high pressure hydraulic fluid takes place during the BGB-E's simultaneously generated downward and upward power stroke whereby the CC2ML is causing the group of PA's which are positioned on one side of its fulcrum to be displaced to their maximum retracted position (˜two feet) while the group of PAs located on the opposite side of the CC2ML are being extended to their maximum extension of (˜two feet). This action generates a total volume of 122.58 gallons of ˜3,098 psi pressurized hydraulic fluid per minute divided by 1714 equals 221.55 horsepower which is continuously generated during the SGPS period and it is immediately transferred to the high-pressure hydraulic accumulators HPHA's storage area. Consequently, the work generated with the production of 122.58 gallons of hydraulic fluid in one minute with an average pressure of 3098 psi divided by 1714 equals, 221.5 horsepower divided by 1.34 equals 164.92 kilowatts.

As mentioned earlier, the CC2ML is locked and unlocked as is required in accordance with the BGB-E, using the flow-control valves which are an integral component in the hydraulic actuators identified as PA. It is important to note that this technique is also used in conjunction with redundant feedback sensors attached to the Hydraulic accumulators identified as HPHA to pause or restart the operation of the BGB-E should the hydraulic accumulator's sensors show that the accumulators have reached their capacity. This action can be instantaneously applied and or frequently applied as the BGB-E's only requirement is that all these actions are to be timed synchronously. The BGB-E does not require a time dependent thermal process for a start-up or a stoppage as many power generation plants require and in some cases some plants require days to accommodate a start-up or shut-down activity. In all circumstances, the control of each BGB-E in a ganged facility will be such that the number of BGB-Es to be placed into service to meet the demand will continuously and automatically be monitored so that the majority of the BGB-Es in a given facility will run continuously to accommodate the variable demand.

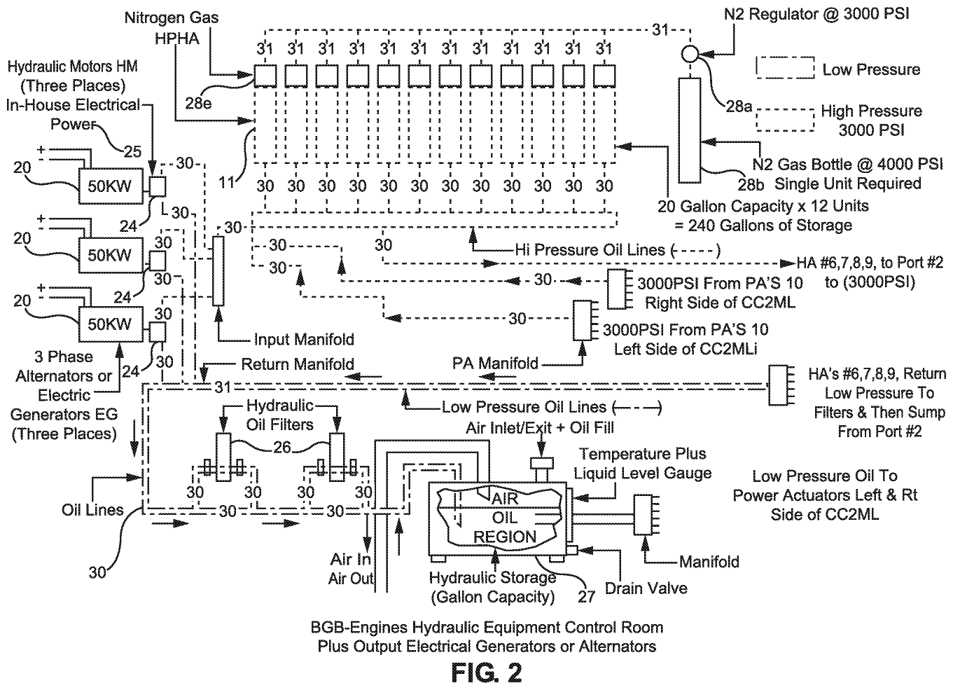

A typical layout design for the various hydraulic and alternator components which are positioned in an air environment enclosure is schematically shown in FIG. 2. This layout design is a standard industry design which is used for High pressure hydraulic systems.

The maintenance of a ganged facility which consists of 50 BGB-Es identified in FIG. 4 can continue to generate power should an individual or a series of BGB-E experience a problem. However, all of the other unaffected Engines will continue to generate power in their normal fashion and the BGB-E with the problem or problems, as determined by sensors mounted on each BGB-E and which are automatically monitored in the control room are used to isolate the problems. Once a problem is analyzed it will be determined what level of maintenance is required. Its operation will be placed into the neutral and locked position. This action effectively stops the operation of that specific BGB-E but does not affect the on-going operation of the facility. The utilization of this capability completely eliminates the need for a back-up power storage system and it is the main reason for the inherent-enhanced-reliability factor identified earlier for the BGB-E.

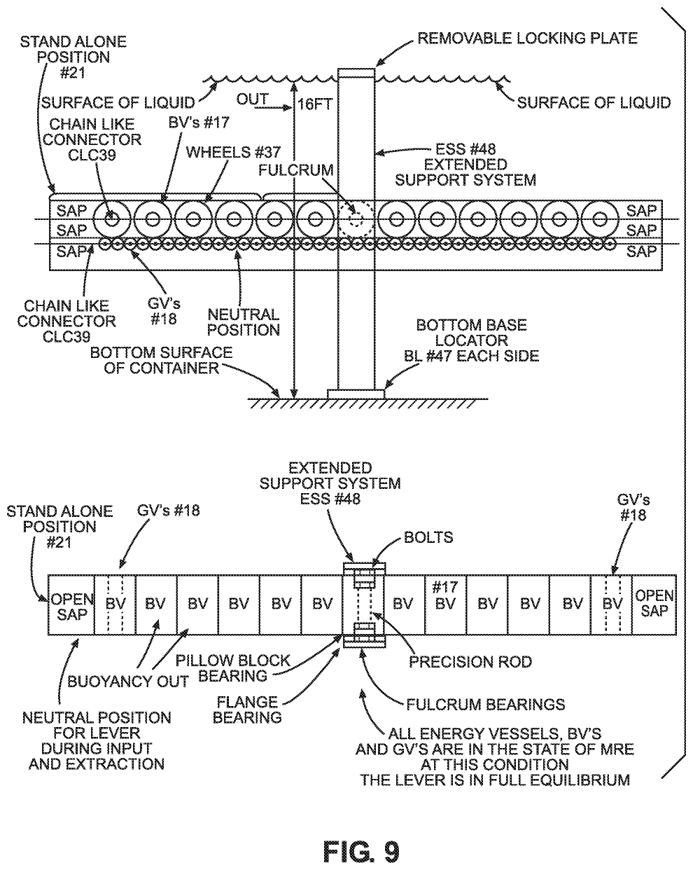

An in-ground, elongated and narrow container IGC which is utilized to accommodate one BGB-E whereby this open top tank which includes a specific number of length segments, of a steel grill cover assembly. These segments could be easily removed by hand in order to reveal the entire open top portion of the tank. Therefore, the entire, completely assembled BGB-E can be lifted using a crane and lowered into the tank. A base locator #47 is permanently attached at each side of the (longitudinal midpoint region) of the container's interior floor elevation. These base locators #47 are used to automatically locate and position the bottom extended fulcrum region of the CC2ML. The use of this technique allows the BGB-E to be fully assembled and lowered into the container with all of the BVs and all of the GVs in the neutralized (MRE) position. FIG. 9 shows a front view and side view of an ESS. The bottom extended region, of the ESS is centered on the fulcrum of the CC2ML, and this section of the ESS is inserted into the base locators (BL) #47 whereby it automatically and exactly positions the overall longitudinal length of the BGB-E inside the container IGC. The top extended region of the CC2ML fulcrum is attached the horizontal top surface of the container and the central region of the ESS contains doubled sealed pivot bearings #42 on each of its sides which are utilized as the fulcrum of the BGB-E. The use of this technique provides for the direct insertion and retraction of a BGB-E from any useful height, narrow-width and extended length container.

The BGB-E also contains a highly unique reliability factor which is inherent in the BGB-E, whereby multiple, totally independent, BGB-Es are coupled together, to provide a fixed level of power output, further supports the earlier statement, that a back-up source of power or battery support will not be required in a BGB-E's In-Ground-Power-Plant-design (IGPP) and also shown in FIG. 4.

The high-pressure hydraulic fluid is continually being generated during the very first ½ SGPS and all future SGPSs thereafter. This high-pressure hydraulic fluid is subsequently stored in standard high-pressure hydraulic accumulators HPHA's which are integral components in the BGB-E. The output from the power stroke, is high pressure 3000 psi hydraulic fluid, which is simultaneously stored as it is being generated, in HPHAs. A hydraulically powered motor HM which utilizes the same source of 3000 psi hydraulic fluid which is also stored in the HPHAs, is used to provide the source of energy necessary to power a standard electric alternator, which in turn outputs useable three-phase AIC electrical power obtained from the operation of the BGB-E. The power generation capability of the BGB-E has the potential for a few Kilowatts to multi-multi-Megawatts of electrical power. This power is typically developed from multiple, BGB-E's positioned in a ganged facility. In FIG. 4 utilizes 50 BGB-Es.

### Miniature Working Model (MWM):

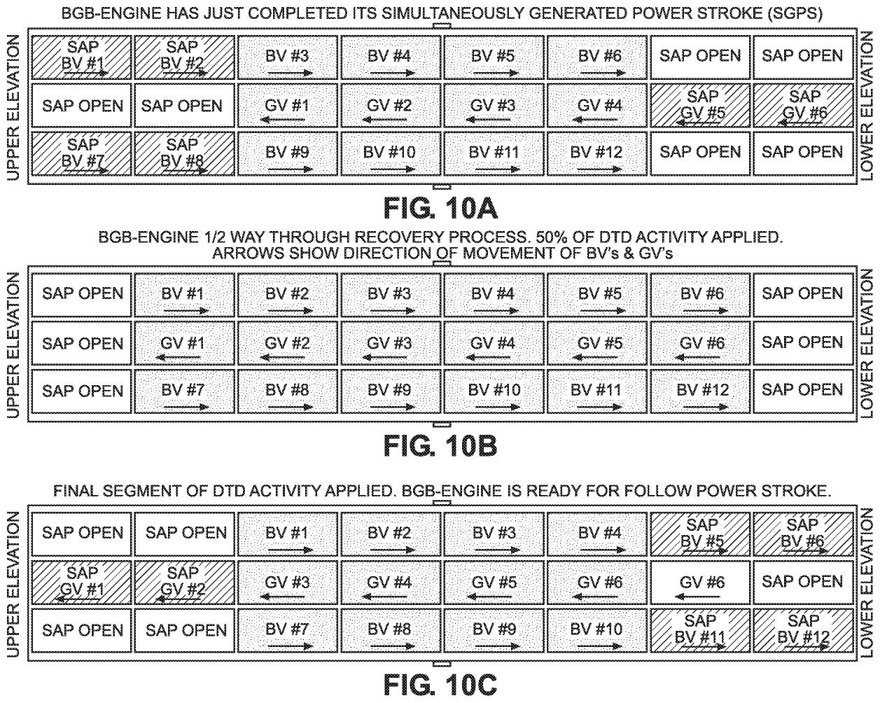

The model is being used to verify the design criteria and to physically demonstrate the important parameters which make the prototype design's capabilities so unbelievable. The MWW consists of a miniature CC2ML, plus a simultaneously generated upward and downward power stroke SGPS which consisted of 13 inches of simultaneous, lever rotational action in each direction, has been developed. The Miniature Working Model MWM is being demonstrated in the fully submerged condition and contains the capability to “evaluate and to certify” the operational characteristics of the DTD activity, the MRE relationships, the SGPS, plus the demonstration of the completely neutral position of the CC2ML; FIGS. 10A through 10C are also utilized to demonstrate and test the process of the MRE and DTD activity.

The following data is authentic results obtained from a series of tests of the BGB-E operational characteristics along with its follow-on 24/7 power generation capability are identified and presented here for the very first time. The measured results from these tests were also utilized to verify the BGB-Es over-all characterization and to compare these measured data with previously generated calculated data.

Referring to FIGS. 1A to 2A, test data involving the positioning of multiple sources of OPES in SAP were measured and calculated data along with Figures showing the top-down view of the MWM are presented.

These tests identify the additional length that is required to be added to each side of the CC2ML in order to demonstrate the variable-power capability of a BGB-E using multiple energy sources for power generation to simultaneously be positioned at multiple SAP locations for a given BGB-E test. The rule-of-thumb developed for this special case is identified in the detailed description of the MWM.

FO-SGPS were conducted for multiple tests, whereby each test demonstrated and verified the 24-7 power output characteristics of the BGB-E. The details of these tests are described in the description of the MWM.

Calculated forces that occur during the generation of a SGPS were also verified with physical measurements: A handheld force measurement gauge was used to reverse engineer a typical SGPS to measure and to verify the exact forces that occur during a standard SGPS. The details are provided in the detailed description of the MWM. A video was generated which physically demonstrates and verifies mutual rotational equilibrium MRE.

FIGS. 1-A, 1-B and 1-C physically demonstrates the parameter identified as the DTD activity. The DTD activity automatically reduces the required total displacement by a factor of two as a result of its differential motion requirement.

The utilization of an Inclined Plane (IP) after each SGPS reduces by a factor of ˜5 in the force required to establish the DTD activity.

A discussion pertaining to the role that friction plays and the action taken to minimize it in the BGB-E: Friction can significantly influence the test results obtained for a BGB-E. Therefore, an extensive study was performed to eliminate the negative influence of friction in the BGB-E. The utilization of wheels plus the restriction that the displacement force would always be limited to a pull force, removed 99.98 percent of the friction.

The establishment and continued utilization of a third source of Potential Energy (PE), which the BGB-E automatically develops: This third source of PE is generated every time a SGPS is being generated as the output from the SGPS which is 3000 psi hydraulic fluid, is sent directly to hydraulic accumulators and is stored at 3000 psi. This PE is utilized to provide all of the work required to perform the DTD activity.

The BGB-E has a sufficient number of BV's and GV's in the proper configuration so that they can rotate in a prescribed manner to this specific location where the combination of their force and the specific location provide the ingredients required for the generation of a torque.

As shown in FIGS. 1A, 1B and 1C, the additional number of BV's and GV's positioned in the SAP requires an increase in the number of spaces to be added to each end of the CC2ML. The General “Rule-of-Thumb” for this added spacing, for the operation of a BGB-E, is based on one half the longitudinal dimension of the BV. In the present test, the BV's longitudinal length dimension is 4.25 inches. Therefore, one half of this value is 2.125 inches, and because two sets of BVs and two GVs are displaced to the SAP for this test, the additional required space dimension is 4.25 inches to be added to each end of the CC2ML. As shown in FIGS. 1A, 1B and 1C, the total number of spaces required for the multiple energy sources of BVs and multiple sources of GVs which are available for the generation of power is eight (8) spaces.

As can be seen in the FIGS. 2A and 2B, the CC2ML includes 2 totally independent class-II mechanical levers which share a common fulcrum so as to generate independent, simultaneous power strokes. Therefore, their combined power stroke is identified as a SGPS. Along with FIG. 2A is a side-view of the CC2ML identified in FIG. 2B, which demonstrates the range of radial motion and other information, which is pertinent to the CC2ML. Additionally, all of the measurements and data obtained from the very first test of a BGB-E are summarized as follows:

Length-in=17 in. for each side of the lever's Fulcrum.

Effective length-in =12.75 in. representing the center of Gravity and Center of Buoyancy for each side of the lever's fulcrum.

Length-out=5.0 in. for each side of the lever's fulcrum.

MA of the Lever=Ratio of effective length-in, to length-out (12.75 in. divided by 5.0 in.=2.55 MA).

Force-in =912 grams times 12.75 in.=a Torque of 11,628 Grams-inch for each side of the lever's fulcrum.

Force-out=force-in 11,628 grams-inch of torque times MA of Lever=2.55=29,651.4 Grams-inch for each side of the lever's fulcrum.

Work-in=force-in of 912 grams-inch times 12.75 in.=11,628 grams-in. of torque times 5.1 inches of stroke which is the levers radial displacement that is representative of the center of Gravity or center of Buoyancy point on the lever which yields a value=59,302.8 gram-inches for each side of the lever's Fulcrum.

The 2-inch Length of distance-out requested for the actuator's displacement which is located at the force-out location on the CC2ML of 29,651.4 grams-inch is a selectable value which obviously, in this case, the distance selected is 2 inches.

Work-out value=29,651.4 Grams-inch for each side of the lever's fulcrum. times distance of the actuators stroke of 2 inches equals 59,302.8 grams-inches for “work-output” for one side of the CC2ML. To change the value of 59,302.8 grams-inches to pound-feet. The 59,302.8 value is divided by 12 inches per foot which yields a value of 4,941.9. Multiplying the 4941.9 value by 0.002205=10.896 pound-feet times 2=21.793 pound-feet of work-output for both sides of the lever.

The Work-in value for one side of the CC2ML is 59302.8 grams-inch is exactly equal to the “work-out” value of 59,302.8 grams-in for one side of the CC2ML, thereby conforming to the laws of the Conservation of Energy.

The slope of the IP identified for this test is based on a MA value of 5.375 which is developed from the following dimensions of 34 inches of length divided by 6.325 inches of height=5.375 MA., see FIGS. 2A and 2B.

Two hydraulic actuators, shown in FIG. 2A, were not attached to the BGB-E during the tests conducted as they normally would be during the normal operations of a BGB-E. However, direct measurements of the “force-output” and the corresponding “work-output” that were calculated over a selectable distance of 2 inches. were recorded and verified which represented one side of the CC2ML.

The calculated work-input for the SGPS from the first BGB-Engine test is 912 grams inch times 12.75 of effective length in which=11,628 grams inches of torque times 5.1 inches of stroke which is representative of the power stroke's length possibility at the COG or at the COB point on the CC2ML, see FIG. 2B. The resulting calculated “work-in” value is =to 59,302.8 grams-inch for each side of the lever's fulcrum or 59,302.8 gram-inches divided by 12 inches per foot=4941.9 times 0.002205=10.896 pound-feet of work per side of the CC2ML or for a total calculated value of work-in =21.793 pound-feet. FIG. 1A is representative of two sources of CPES including BV and GVs whereby, each energy source is represented twice. As shown in the Figure, two units of gravitational force numbers #5 and #6 are located in their respective stand-alone positions and four units of Buoyancy Force, #1, #2, #7 and #8 are located in their respective stand-alone positions. As can be seen, the remaining BVs and GVs are in the state of MRE. It is important to note that at this particular time the right side of the CC2MI is positioned at its upper-most elevation whereas the left side of the CC2ML is positioned at its lower-most elevation. Additionally, the CC2MI is locked in position at this point using the control valves for the PA which are shown in FIG. 2A. The configuration identified in FIG. 1A is now ready to perform its simultaneously generated power stroke SGPS. The calculated work-input for this SGPS is 912 grams-inch times 12.75 inches of effective length-in which=11,628 grams-inches of torque times 5.1 inches of available stroke which is representative of the power stroke's length possibility at the COG or at the COB point on the CC2MI, see FIG. 2B. At this time, the first test ever utilizing a BGB-E was conducted, as the locking mechanism for the CC2ML was released and the SGPS with the configuration of FIG. 1A was initiated. The power stroke only required a few milli-seconds to complete. At this time period. the right side of the CC2ML is at its minimum elevation and the left side of the CC2ML is at its maximum elevation. All of the measurements and data obtained from this very “first test of a BGB-E” are summarized in the highlighted-button-area presented in the previous text of this document.

Our present goal is to identify the amount of pre-work required to implement the application of the DTD activity. Therefore, since we already have test data for FIG. 1A, we can now apply the DTD activity to such a configuration as this configuration has just completed its SGPS and the right side of the CC2ML is at its minimum elevation and its left side is now at its maximum elevation which is a typical set of conditions that occur during the normal operation of a BGB-E. The application of the DTD activity will change the configuration shown in FIG. 1A to a “follow-on” test condition which has previously been established and is shown in FIG. 1C. The goal at this point, was to demonstrate and to verify the important characteristics of the BGB-E. Running the first ever, physical test, was paramount for this demonstration. The configurations of the BGB-E shown in FIG. 1A, and also in FIG. 1C, are the two configurations where the BGB-E will be utilizing on a continually-alternating basis throughout its operations. It is important to note that any work utilized to perform the DTD activity is obtained from HPHA which are an integral part of the BGB-E. These accumulators receive high-pressure 3000 psi hydraulic fluid every time a power stroke of the BGB-E is generated whereby the mechanical work-input to the CC2ML resulting from the CC2ML's radial motion generated during the SGPS, is used to power hydraulic actuators, whereby these high pressure hydraulic actuators utilize this high force mechanical work to simultaneously transfer this mechanical work to the push or pull rods from the hydraulic actuator's which are attached to opposite sides of the CC2ML's fulcrum. The opposite ends, of the hydraulic actuator's pull or push rods are directly connected to the actuator's internal pistons which are utilized to displace high pressure hydraulic fluid from the hydraulic actuators at 3000 psi pressure. It is obvious that the force-output of 29,651.4 grams times 2 inches of extension or retraction, as the case may be, yields a value for work-output of 59,302.8 gram-inches per side of the CC2MI. This work-output is used to generate high-pressure {3000 psi) hydraulic fluid which is stored in Hydraulic Accumulators as another source of potential energy PE that is immediately available for any purpose in the BGB-E. This PE is then immediately available for use during and following, the very first one-half power stroke that is being generated at the start-up of the BGB-E. Obviously, since the simultaneous Power Stroke occurs before the DTD activity, this PE is available for use to provide the power for the first requirement of hydraulic power for the HAs or hydraulic motors that are used to displace the BVs and GVs during the application of the DTD activity.

The Steps of the DTD Activity Changing from the Conditions Shown in FIG. 1A to that Shown in FIG. 1C.

It is important to note that all differential displacements occur simultaneously. The BVs and GVs are all totally independent units and in the case shown, the numbered segments for all BVs and all GVs are 4.25 inches in length and are identified by the type of vessel and the condition of the physical state of each vessel. Additionally, each BV or GV is fully submerged and fully exposed to the liquid environment and all of the vessels remain totally independent units throughout their existence with the one exception. A chain like connector constitutes the exception and it is only operable in the longitudinal direction as the vertical and rotational capabilities of each BV or GV continuously remain unaffected. Its purpose is to maintain a fixed distance between each BV and each GV and is also utilized to transfer only a pull force to each line of BV's or to a single line of GVs during the application of the DTD activity.

The system configuration utilized for this very first test of a BGB-E is the new MWM, which is a direct representation of the BGB-E. However, in the prototype design, which is under construction, the BVs and GVs are mounted on wheels which are attached to each end of the BVs or GVs and an upper and lower track is attached to the CC2ML to provide a path for the wheels to ride on. The balance of the BVs and GVs volume are fully exposed to the liquid environment. The wheels have axles with double layer ball bearings and a chain like connector to maintain critical spacing between units and to allow each vessel to continuously rotate freely in order to continuously maintain its COG and or its COB. Additionally, the chain like connectors are also used to pull the lines of BV's or the line of GV's to accommodate the displacements required. (see video example: https://www.youtube.com/watch?v=VQjUMOZmlo).

It is important to note that displacements performed “differentially” only need to displace one-half of the normally expected distance in order to accommodate a total displacement requirement. In all cases, the displacement of BVs will always occur in a direction which is opposite to the displacement of the GVs and the GVs will always be displaced in the opposite direction of the BVs. This differential motion minimizes the total displacement by a factor of 2.

Additionally, the utilization of the MA of an IP automatically reduces the net force required to displace BVs or GVs as the MA value from the IP is automatically available for use at the end of each BGB-E power stroke. The values utilized to develop a MA value of 5.375 are identified in FIG. 2B. The utilization of the MA value of 5.375 is representative for the GVs as well as for the BVs. However, the weight of each GV is 456 grams and its length is 4.25 inches. Dividing 456 grams by 4.25 inches yields a length to weight ratio of 107.29 grams per inch of displacement and dividing 107.29 by the MA value of 5.375 equals 19.966 grams per inch of effective pull force that is required for the GV's being displaced along the Inclined Plane IP. Additionally, a similar analysis is available for BVs, however, each of the BVs initial force capability is only 228 grams and the BVs length is 4.25 inches. which automatically yields a value of 53.647 grams per inch. The effective pull force for the BVs utilizing the MA value of the IP of 5.375 grams yields a length to force ratio of 9.980 grams per inch for the BV's displacement.

Also, another important factor for consideration, is the interaction between BVs or GVs as they are being displaced to a position where they mate with each other or these BVs or GVs interact with a respective SAP or what-ever the case may be. In these cases, the force that is normally required for that specific increment of displacement will continually be reduced to a zero value as a result of the BV or GV or another type of interaction which will now cause these BVs or GVs to mate and become established in the state of MRE. In all cases, the DTD activity will always displace BVs and GVs back to their respective neutral positions during the first phase of the DTD activity.

The DTD activity is now utilized to reposition OPES of BVs and GVs from their prior locations in the SAP as shown in FIG. 1A. In the configuration shown in FIG. 1A, the MWM has just been utilized to complete the very first SGPS utilizing a BGB-E. It would therefore, be normal procedure to generate a FO-SGPS as the BGB-E with the configuration of FIG. 1A is presently at the proper elevation to initiate and to perform the DTD activity.

Therefore, it is first necessary to differentially displace lines of BVs and a line of GVs and return them back to their neutral respective positions on the CC2ML. At the completion of this activity which corresponds to a 50 percent completion of the DTD activity, all of the BVs and GVs mounted on the CC2M, are all in the state of MRE as is shown in FIG. 1B. The goal of the DTD activity is to modify FIG. 1A. using the DTD activity to duplicate the pre-programmed configuration that has previously been established in FIG. 1C. The configuration shown in FIG. 1A is the normal “Follow-on” configuration which would result from the normal application of the DTD activity to achieve this change.

Referencing FIG. 1A, describing the associated changes from a small displacement when physically displacing the two lines of BV and the single line of GV, shown in FIG. 1A, a distance of one-half the length of a BV or 2.125 inches includes the following: a pull force simultaneously applied to the line of GVs at GV #1 and to the line of BVs at BV #6 and also to the line of BVs at BV #12. The differential action that results causes the line of BV's #1 thru BV #6 and the line of BVs #7 thru BV #12 to displace 2.125 inches to the right side of the CC2ML while simultaneously the line of GV's #1 thru GV #6 is displaced 2.125 inches to the left side of the CC2ML. An over-all-view of the CC2ML at this moment is shown in FIG. 1B.

As can be seen in FIGS. 1-12, all of the BVs and GVs are now in the state of MRE at this point which is representative of the completion of the first segment, or 50 percent of the DTD activity. However, the important changes are as follows: GV #1 now occupies 4.25 inches of the open-SAP area and it shares its new MRE status with BV #1 and BV #7. BV #6 and BV #12 now occupy 4.25 inches of open-SAP area while simultaneously BV #6 and BV #12, retain their new MRE status as GV #6 gains its new MRE status from them. GV #5 is now sharing MRE status with BV #5 and BV #11. BV #2 and BV #8 gain MRE status as they now share their MRE status with GV #2. BV #1 and BV #7 share their newly gained MRE status with GV #1. At this moment the entire assembly of BV's and GV's are in the state of MRE and the net displacement for each line of energy sources was 2.125 inches, and their resulting configuration is shown in FIG. 1B.

The “bottom line” for the GVs is a force of 19.966 grams-inches times 2.125 inches of displacement requires a force of 42.478 grams-inch for the line of GVs. Simultaneously, a force of 9.980 grams-inch times 2.125 inches of displacement for each line of BVs requires 21.2075 grams-inch per line or 42.415 grams-inch for both lines of B's. At this point, the first segment of the DTD activity is complete and the configuration of the data in FIG. 1A at this point has changed to its new configuration. which is representative of the configuration of the data provided in FIG. 1B. The DTD activity is now ready to apply its final Displacement segment to the configuration shown in FIG. 1-12, which at this moment, is actually, the instantaneous representation of FIG. 1A. At this point the line of GV's is further differentially displaced a total distance of 2.125 inches to the left side of the CC2ML. This action requires 19.99 grams-inch times 2.125 inches, which yields a value of 42.478 gram-inches. Simultaneously, the two lines of BV's are differentially displaced 2.125 to the right side of the CC2ML, which requires 9.980 grams-inch times 2.125 inches of displacement per line of data or 21.2075 grams-inch per BV line, or 42.415 gram-inch for both lines of BV's. At this point the OTO activity is complete and the resulting instantaneous configuration of FIG. 1A, is now an exact copy of FIG. 1C which was the goal. FIG. 1C is now ready to generate a “follow-on” SGPS. The total pre-work required during this configuration change from FIG. 1A to FIG. 1B and finally to FIG. 1C is 169.786 gram-inches. It is important to note that the total work utilized to perform the DTD activity, came from the hydraulic energy stored in the HPHA. The work-output of 59,302.8 grams-inches which was obtained for one side of the CC2MI during the first test ever conducted using a BGB-E where the original configuration for FIG. 1A was utilized. Subsequently, the value of “work-output” value of 59,302.8 gram-inches was multiplied by 2 which yields 118,605.6 grams-inches of total “work-output” that resulted from the very first test where the BGB-E was utilized. The ratio between the total pre-work of 169.786 grams-inches divided by 118,605.6 grams-inches equals 0.00143 percent. Subtracting the value of 0.00143 percent from 100 percent efficiency equals 99.9985 percent efficiency.

Therefore, the total amount of work required to fully accommodate the DTD activity is 669.7 foot-pounds of work. The “work-in” for a SGPS which is provided by the forces being generated by OPES in accordance with the BGB-E's Prototype design #34, whereby the summation of the simultaneously generated upward and downward power stroke SGPS #5 yields a value for work of 363,468.8 foot-pounds. Dividing the OTO work of 669.7 foot-pounds by 363.468.8 foot-pounds of “work-in” yields a value of 0.001842 percent: Without consideration to any other factors, this ratio gives proof that the BGB-E's prototype is 99.9981 percent efficient”.

As can be seen, the values of 0.00143 percent is very close to the value of 0.001842 obtained from the data from the prototype referenced in the Provisional Patent Application even though the MA value from the inclined plane data was 5.48 from the provisional data versus the MA value of 5.375 for the data being generated presently. Additionally, the values for effective efficiency of 99.998 percent was calculated for the provisional data BGB-E test that utilized 1,832 pounds of force times a lever's “length-in” value of 16 feet per side for the CC2ML versus an actual BGB-E test conducted using 912 grams of force times 12.75 inches of “length-in” or 11,628 gram-inches of torque versus 29,312 pound feet of torque for the provisional data. The actual test presently conducted yielded an effective efficiency value of 99.9985 percent. The close agreement in the efficiency data obtained for the tests referenced above where their parameters are orders of magnitude apart, gives credence to the repeatability of the calculated data versus the actual measured data that was generated for the series of bona-fide BGB-E test conducted in this evaluation.

The test configuration shown in FIG. 1C was a predicted configuration which has just been exactly duplicated as the application of the OTO has just been completed. The configuration of the design presently established in FIG. 1C was originally established in FIG. 1C to demonstrate the performance of a “Follow-On” test by initiating a simultaneously generated power stroke SGPS. Following the completion of the DTD activity the BGB-E is now ready to demonstrate and to verify the 24/7 characterization of the BGB-E by performing the first “follow-on SGPS” demonstration, utilizing its MWM to perform the test. Measurements, plus calculated data were obtained, to verify the 24/7 capability of the BGB-E. The data obtained from the first “follow-on test” duplicated the data generated earlier, which are identified in this document, as highlighted bullet symbols. Both measured and calculated data were in full agreement as expected and the successful completion of the “follow-on” SGPS has confirmed the 24/7 characterization of the BGB-E.

I utilized the inclined plane (IP). as my measurement reference device. Accurate slope changes were easily established and the expected Mechanical Advantage MA values were well defined. Any deviation from the expected values was easily recognizable as friction values, which caused the forces for a given displacement to be greater than that calculated or expected. I subsequently, placed 4 wheels with ball-bearings attached so as provide the support for the vessel which I was using originally. This vessel was used in the sliding fashion originally and now it is necessary to repeat the same exact test series for IP slopes with MA values ranging from zero to 7.0 that were initially evaluated. The results from this study showed a significant decrease in the friction contribution at all the (IP) slope changes evaluated. An appropriate correction factor was subsequently applied to the sliding data being generated as the friction contribution was now easily separated.

A third test is now being conducted using the BGB-Es design, to obtain calculated data and also, to directly measure the power output of a SGPS. The results from these measurements will verify and establish the reliability of only using calculated data to describe the test results. The configuration shown in FIG. 3 was placed onto the MWM with the CC2ML locked in place and the MWM was completely submerged. The starting position for the configuration shown in FIG. 3 represents a condition whereby the CC2ML has its right side at its maximum elevation and its left side at its minimum elevation. The BGB-E is now ready to perform its third SGPS. Releasing the locking mechanism on the CC2ML, immediately initiates the SGPS. As the right side of the CC2ML immediately moves downward by a Gravitational force, the left side of the CC2 ml simultaneously moves upward by a buoyancy force. This activity only requires a few Mille-seconds to complete. The calculated results from this test were subsequently analyzed and compared with the data obtained from the very first test conducted using the BGB-E. The results from test #3 duplicated the calculated results obtained from the very first test conducted using the BGB-E.

In order to demonstrate the difference between calculated data versus physically measured data, the submerged CC2ML of the BGB-E's MWM was physically pulled from its present position where it has just completed its third SGPS. The goal is to physically measure the force that is required to reposition the CC2ML back to its initial starting point before it started the third SGPS in the test series. Actual measurements of the power stroke were taken using a digital force gauge with a capability of resolving a force within the precision of, plus or minus one gram. Due to the difficulty-factor associated with directly measuring the SGPS, which required a few milliseconds of response capability, the force was physically, provided and the magnitude of the force that is required to return the CC2ML back to its pre-SGPS position (back down the IP) was simultaneously measured, and simultaneously the actual force required to pull the gravitational force back up the IP to its pre-SGPS position was also measured. The use of this procedure provided a total force measurement of 1,824 grams-inches which is approximately 4 pounds of force. Initially a line from the measuring device to the gravitational side of the CC2ML was attached to the COG point located on the CC2ML. The use of this procedure provided a force measurement of 1,824 grams-inches. Additionally, the stroke distance which was recovered and identified during the application of this procedure was 5.1 inches, which is as expected as a physical stopping mechanism, which is also used to maintain the same value for the Inclined plane was attached to the MWM earlier on the bottom surface of each end of the CC2ML which automatically established a fixed distance of 5.1 inches. The 1,824 grams-inch of force measurement represented the total force that was required to pull the buoyancy side of the CC2ML in a downward direction while simultaneously. the gravitational side of the CC2ML, was being pulled in an upward direction. No correction factor was required at this point for friction, so the force measurement value is representative of the actual force condition measured in this reversed engineered special test. In order to analyze the results from this special test it is important to understand that the force physically generated and simultaneously measured represented the capability, of four (4) BVs positioned in the SAP, whereby each BV unit contained the capacity to generate 228 grams of force each or a force of 912 grams of force collectively. Simultaneously two (2) GVs, which each generate a force of 456 grams or collectively generate 912 grams of force are positioned in the SAP on the opposite side of the CC2ML. Therefore, since the buoyancy and gravitational forces are identical in magnitude but opposite in direction the measured value of force of 1824 grams applied to the gravitational side may be divided by 2 which equals 912 grams of force for buoyancy and 912 grams of force for gravity. Obviously, torque, is the measured value being required in this evaluation. The distance from the COG to the fulcrum is a physically measured value which is equal to 12.75 inches for each side of the CC2ML. However, at this point. The value of 12.75 inches times a measured effective force value of 912 grams-inch=11,628 grams-inch of torque. Subsequently, to continue the analysis of the reversed engineered SGPS, a torque value of 11,628 will be applied to each side of the CC2ML. At this point, using the 5.1 inches of distance which occurs on each side of the CC2ML yields a value of 59.302.8 grams-inches of work for buoyancy and 59302.8 grams-inch of work for gravity. Multiplying the work which these sources of energy have demonstrated they have the capacity, yields a value of 118,605.6 grams-inch for the total amount of work that was physically expended while performing a reversed engineered SGPS. A value of 118,605.6 grams-inch is identical to the calculated value obtained for the “work-input” from a SGPS which was generated for the “follow-on SGPS” demonstration.

This is the first Bona-Fide test conducted utilizing the conditions identified for a BGB-E where calculated data were generated, along with specific physical measurements of the SGPS forces were obtained. The calculated work was initially generated in less than one second so that 21.793-pound feet of work per second divided by 550-pound feet yields a value of 0.03962 horsepower, which occurs in milliseconds. The time constant of a few milliseconds for the SGPS was obtained from the actual test. However, the directly measured forces that were generated during the application of the reverse action of the SGPS returned back as energy to the sources of energy. Buoyancy and gravity which existed at their starting position by physically attaching a line to the CC2ML at the COG point identified in FIGS. 2A and 2B. The opposite end of this line was attached to a digital force gauge whereby physically generated force to the submerged CC2ML through the attachment line. This action returned the gravity generated force up the IP to its pre-SGPS position, while simultaneously this same action was pulling the buoyancy force down the IP to its pre-SGPS position. This action resulted from my physically generated force and my directly measured force.

Thus, this SGPS test configuration was “reversed engineered” to yield a “reversed SGPS” which yielded directly measured data, which were shown to be identical to the calculated data obtained for the third “Follow-on” SGPS. Video support is provided in the following format:

| | |
|---|---|
| 1. | BGB-E MWM demonstrating MRE: |
| | https://www.youtube.com/watch?v=OgCrSxFOHs |
| 2. | BGB-E Prototype: https:lj www.youtube.com/watch?v =K3J |
| | IEHC19c |
| 3. | BGB-E Track System: |
| | https://www.youtube.com/watch?v=VQjUMOsZmlo |
| 4. | BGB-E MWM starting position: https:// |
| | www.youtube.com/watch?v=-XPV 90t2 LdU |

The demonstration of the neutral position condition is also automatically established during the start-up condition for the BGB-E's prototype, whereby the CC2ML is fully loaded with representative Buoyancy Vessel's (BV's) and Gravitational Vessel's (GV's). All of the BV's and all of the GV's are in the state of MRE as is shown in FIG. 1A. Therefore, it was very important to physically demonstrate this condition. The testing included a difficult condition whereby only “one side” of the miniature, balanced and submerged-lever, was fitted with 12 miniature BVs and 6 miniature GVs which were configured to be in the state of Mutual Rotational Equilibrium in accordance with the required relationships of MRE as defined in this manuscript. The result of the submerged test showed the initial balance of the miniature lever was “unaffected” by the addition of the six sets of miniature Buoyancy vessels and six Gravitational vessels whereas, two BVs were required for one GV to establish a set, which was the requirement for the MRE relationship. The miniature lever's horizontal balance condition did not change from its initial balance condition even though 12 BV's and 6 GV's were only positioned on one side of the miniature lever's fulcrum. This result was immediate verification for the use of MRE in the BGB-E.

Additionally, the use of the MWM model also provided for the verification of the idea, of the SAP for the BV's and GV's, plus provided a review of many different designs involving various stacking configurations for the BV's and GV's as to their respective placement onto the miniaturized CC2ML. More importantly however, fingertip power was simultaneously applied to both ends of the CC2ML model, in lieu of hydraulic actuators. This action allowed for the direct simulation of the DTD activity which provided for, the direct demonstration of the usefulness of the two main “Omni-present” potential or kinetic energy sources utilized in the BGB-E's prototype, namely Gravity and Buoyancy which are used throughout the BGB-E. These two “Omni-Present” energy sources OPES were shown to simultaneously provide work to their respective sides of the miniature CC2ML to cause the CC2ML to rotate through its designed stroke with-in a few milliseconds of time. The overall success of the physical demonstrations conducted during this evaluation verified the usability of all of the concepts which are presently established in the BGB-E. These results also provided proof that the BGB-E is a significant source of decentralized electrical power by extrapolating the power output of the model's power stroke.

Although, the BGB-E operates in the fully submerged condition, its applications are endless when the BGB-E is positioned in an enclosed container whereby this container can be fitted into city busses, RV motor homes, large luxury yachts, cargo ships and many other transportation devices. These enclosed containers can also be designed to fit into a three-feet wide six-feet high, 15 to 20 feet long space of a resident's garage that will continuously supply all of the electrical power requirements which an average residence utilizes annually. A similar design can be used for corporations, hotels, hospitals and as one can see the list goes on. The inventors real goal is to establish a highly unique elevated rapid transit system throughout the world where Decentralized Power Plants which will look like pristine lakes will be positioned every 50 to 100 miles apart to supply all of the Decentralized Power Plants electrical needs for the operation of the rapid transit system plus will supply all of the electrical power needs for those who live in the vicinity of the rapid transit system. With the proper elevated support system design, a 300 MPH system with a linear induction motor (LIM) for its traction power whereby it only requires power at the specific locations which it is moving through, and would easily maintain the referenced speed. As one can see the BGB-E is a Global product and its utilization will have a profound and highly beneficial effect on our way of life.

The decentralized power may be used to provide inductors embedded in the roadway to provide electrical power to the electric vehicles passing over and along the lanes dedicated for this type of transportation. This type of transportation will also be controlled so that the vehicles used for this mode of travel will contain sleeping quarters much like miniature motor home. BGB-Es will also be fitted into the new electric automobiles so that once they leave the electrified roadway, the on-board enclosed BGB-E will utilize hi-torque small hydraulic motors attached to each of the 4 wheels which will subsequently be “driver-selectable”. Additionally, the on-board BGB-E will be used to power this vehicle as the operator desires.

The third major goal is to provide decentralized power plants along our southern border at the intervals identified above to supply electrical power for any need which the border requires. Especially to provide electrical power for patrol vehicles of all type used for this purpose. Additionally, the residents along the wall can receive their electrical power directly from the decentralized power plants positioned at intervals along the wall which will help to offset the capital and maintenance cost of the decentralized BGB-E power plants plus help to offset the cost of the wall.

As one can see the BGB-E will have a significant impact on our way of life as it will be used to provide an extremely economical solution to our expected “World-Wide” water shortage problem. Desalinization plants, powered with decentralized BGB-Es, could be built along the coast of the oceans of the world and the power required to distribute this desalinated water to locations of need, will also use decentralized BGB-Es power plants to supply the pumping power required for this activity. New cities can be established along regions of desalinization plants much the same as cities originated along railroads and rivers years ago.

The problem of global warming will seriously and automatically be addressed, as the BGB-Es operation is “totally green”. Therefore, with the utilization of BGB-Es and BGB-E power plants throughout the world will certainly reduce the present concentration of CO2 in our environment.

Our land or sea-based modes of transportation will be operated with electricity or hydraulics supplied by BGB-Es which will make a significant contribution to maintaining the level of air-quality which we humans need “to thrive” not just “survive”.

Sewerage treatment plants can now, with the use of extremely inexpensive electricity, can further process sewerage for the development of safe products which will be beneficial to the population and no longer a serious liability.

It is obvious that the BGB-E will support our way of life in so many ways and its use is only limited by our “imagination” as stated by the Inventor.

It should be understood, of course, that the foregoing relates to exemplary embodiments of the invention and that modifications may be made without departing from the spirit and scope of the invention as set forth in the following claims.

What is claimed is:

1. A power generator, comprising:
a compound lever comprising two class II mechanical levers sharing a common fulcrum; and
at least one active energy unit comprising:
one gravitational vessel positioned in an initial position along the compound lever; and
two buoyancy vessels for said gravitational vessel and spaced apart therefrom, wherein the two buoyancy vessels contain the same net weight as said gravitational vessel net weight so that the two buoyancy vessels and said gravitational vessel have the same torque with opposite polarities relative to the fulcrum.

2. The power generator of claim 1, wherein each class II mechanical lever performs a power stroke simultaneously yet independently of each other when pivoting about the fulcrum.

3. The power generator of claim 2, further comprising a hydraulic actuator operatively associated to each side of the fulcrum, wherein each hydraulic actuator actuators is configured to use mechanical force from radial motion of the compound lever generated during each power stroke.

4. The power generator of claim 3, further comprising one or more high-pressure hydraulic accumulators coupled to each hydraulic actuator for retrievably storing hydraulic pressure for providing continuous source of a potential energy to the hydraulic actuators.

5. The power generator of claim 1, further comprising:
an upper track and a lower track spaced apart along the composite lever;
an axle attached each buoyancy and gravitational vessel;
a set of wheels mounted to each axle; and
each set of wheels operatively associated with the upper or lower track, wherein each gravitational vessel is engaged with the lower track.

6. The power generator of claim 5, further comprising: a chain like connector placed around each axle for enabling rotation and vertical displacement without being restrained.

7. The power generator of claim 1, wherein each of the buoyancy and gravitational vessels are positioned along the composite lever so that an initial force of each vessel becomes a respective torques once so positioned.

8. The power generator of claim 7, wherein the respective torques of the gravitational vessels have an opposite polarity than that of the two buoyancy vessels of each active energy unit so that a summation of said respective torques will be equal to zero.

9. The power generator of claim 4, further comprising a stand-alone position provided at each opposing ends of the composite lever, wherein a differential translational displacement by way of the potential energy displaces each gravitational vessel from the initial position to an adjacent stand-alone position to generate power.

10. The power generator of claim 4, further comprising:
an elongated container dimensioned and adapted to accommodate the composite lever; and
base locator interconnecting the fulcrum and an interior floor elevation of the elongated container.

11. The power generator of claim 1, wherein the composite lever is submerged in water.

12. A power generator, comprising:
a compound lever comprising two class II mechanical levers sharing a common fulcrum;
at least one active energy unit comprising:
one gravitational vessel positioned in an initial position along the compound lever;
two buoyancy vessels for said gravitational vessel and spaced apart therefrom, wherein the two buoyancy vessels contain the same net weight as said gravitational vessel net weight so that the two buoyancy vessels and said gravitational vessel have the same torque with opposite polarities relative to the fulcrum, wherein each class II mechanical lever performs a power stroke simultaneously yet independently of each other when pivoting about the fulcrum, wherein each of the buoyancy and gravitational vessels are positioned along the composite lever so that an initial force of each vessel becomes a respective torques once so positioned, and wherein the respective torques of the gravitational vessels have an opposite polarity than that of the two buoyancy vessels of each active energy unit so that a summation of said respective torques will be equal to zero;
a stand-alone position provided at each opposing ends of the composite lever, wherein a differential translational displacement by way of the potential energy displaces each gravitational vessel from the initial position to an adjacent stand-alone position to generate power;
a hydraulic actuator operatively associated to each side of the fulcrum, wherein each hydraulic actuator actuators is configured to use mechanical force from radial motion of the compound lever generated during each power stroke;
one or more high-pressure hydraulic accumulators coupled to each hydraulic actuator for retrievably storing hydraulic pressure for providing continuous source of a potential energy to the hydraulic actuators;
an upper track and a lower track spaced apart along the composite lever;
an axle attached each buoyancy and gravitational vessel;
a set of wheels mounted to each axle;
each set of wheels operatively associated with the upper or lower track, wherein each gravitational vessel is engaged with the lower track; and
a chain like connector placed around each axle for enabling rotation and vertical displacement without being restrained.

13. The power generator of claim 12, further comprising:
an elongated container dimensioned and adapted to accommodate the composite lever; and
base locator interconnecting the fulcrum and an interior floor elevation of the elongated container.

14. The power generator of claim 12, wherein the composite lever is submerged in water.
